(19) United States
(12) Patent Application Publication
(10) Pub. No.: US 2007/0237485 A1
(43) Pub. Date: Oct. 11, 2007

(54) Optical Fiber Rewinding Apparatus

(76) Inventors: Ho Seop HAN, Seoul (KR); Ho Kyung LEE, Kyeonggi-do (KR)

Correspondence Address: BRUCE E. LILLING;LILLING & LILLING PLLC, P.O. BOX 560, GOLDEN BRIDGE, NY, 10526, US

(21) Appl. No.: 11/689,820

(22) Filed: Mar. 22, 2007

(30) Foreign Application Priority Data
Mar. 23, 2006 (KR) 10-2006-0026376

(51) Int. Cl. G02B 6/00

(52) U.S. Cl. 385/134

(57) ABSTRACT

Disclosed herein is an optical fiber rewinding apparatus that is configured to readily adjust an amount of an optical fiber to be rewound and to automatically perform processes of rewinding the optical fiber and taping an optical fiber roll thus rewound. The optical fiber rewinding apparatus in accordance with the present invention rewinds a predetermined amount of optical fiber from an optical fiber bobbin on which a large amount of the optical fiber is wound, the apparatus comprising: a pay-off unit 10 supplying the optical fiber to be rewound; a cutting unit 50 cutting the optical fiber supplied from the pay-off unit in a predetermined length; a take-up unit 70 winding the optical fiber supplied from the pay-off unit to form an optical fiber roll; a tape supply unit 80 supplying tape for taping the optical fiber roll; a taping unit 90 taping the optical fiber roll rewound by the take-up unit; and a controller controlling optical fiber rewinding processes.

### CROSS-REFERENCE TO RELATED APPLICATION

This application claims the benefit of Korean Patent Application No. 10-2006-0026376, filed on Mar. 23, 2006, the entire disclosure of which is hereby incorporated by reference.

### BACKGROUND OF THE INVENTION

1. Field of the Invention

The present invention relates to an optical fiber rewinding apparatus and, more particularly, to an optical fiber rewinding apparatus that is configured to readily adjust an amount of an optical fiber to be rewound and to automatically perform processes of rewinding the optical fiber and taping an optical fiber roll thus rewound.

2. Description of Related Art

Optical fiber is generally made of plastic, glass, etc. The optical fiber comprises a core layer and a clad layer surrounding the core layer. The core layer is used as a path through which light is transmitted and the clad layer prevents the light transmitted through the core layer from leaking to the outside. Incident light into the optical fiber is totally reflected to the core layer by the clad layer. Since the optical fiber can transmit the incident light for a long distance without a large loss, it is mainly used in the communication field.

Especially, with the rapid spread of Internet usage and the increase in users' demand for multimedia information, various types of optical transmission systems have been developed and thereby optical networks using such systems have been constructed rapidly. Moreover, with the rapid spread of such optical networks, the demand for multi-core optical fibers, i.e., ribbon optical fibers is increased sharply.

The ribbon optical fiber is generally configured in a form in which a ribbon coating layer surrounds an outer surface of a plurality of optical fibers. In general, the ribbon optical fiber is provided in the form of a roll in which the ribbon optical fiber is wound on a bobbin in a predetermined length, for example, 10 km or more at the time of a shipment from a factory. Accordingly, a worker should rewind the ribbon optical fiber as much as necessary from the optical fiber roll to use the same in the field of constructing a communication network.

The rewinding process of the ribbon optical fiber has depended on manual operations of workers because there has not been developed an appropriate apparatus for rewinding the ribbon optical fiber in the past. However, such manual operations require a long working time and cause a problem in that the ribbon optical fiber is damaged in the rewinding process.

Accordingly, the inventors of the present invention have disclosed an optical fiber rewinding apparatus that automatically rewinds a ribbon optical fiber of a predetermined length from a ribbon optical fiber roll in the Korean Patent Application No. 10-2002-00048471 (Publication No. 10-2006-0127469).

However, the above invention has a problem in that a worker should be positioned beside the apparatus to perform processes of taping a rewound optical fiber roll and loading the taped optical fiber roll, since only the process of drawing the optical fiber from the optical fiber roll to rewind the same in a predetermined length is automated.

Such a problem occurs in an ordinary single-core optical fiber rewinding apparatus in the same manner, not limited to the multi-core optical fiber such as the ribbon optical fiber.

### SUMMARY OF THE INVENTION

Accordingly, the present invention has been contrived to solve the above-described drawbacks, and an object of the present invention is to provide an optical fiber rewinding apparatus that performs a series of processes from rewinding to taping the optical fiber full automatically.

Moreover, another object of the present invention is to provide an optical fiber rewinding apparatus that effectively rewinds a single-core optical fiber as well as a multi-core optical fiber.

To accomplish the above objects, there is provided an optical fiber rewinding apparatus rewinding a predetermined amount of optical fiber from an optical fiber bobbin on which a large amount of the optical fiber is wound, the apparatus in accordance with the present invention comprising: a pay-off unit supplying the optical fiber to be rewound; a feeding unit feeding the optical fiber supplied from the pay-off unit to a take-up unit; a tension adjusting unit maintaining a tension of the optical fiber supplied from the pay-off unit to the feeding unit at a constant level; a cutting unit cutting the optical fiber supplied from the pay-off unit in a predetermined length; a take-up unit winding the optical fiber supplied from the pay-off unit to form an optical fiber roll; a tape supply unit supplying tape for taping the optical fiber roll; a taping unit taping the optical fiber roll rewound by the take-up unit; and a controller controlling optical fiber rewinding processes.

Moreover, the feeding unit comprises: a first driving roller and a second support roller that are driven by being engaged with each other; a first driving motor driving the first driving roller; and a first guide roller guiding the optical fiber supplied from the tension adjusting unit to the side of the driving roller, and a shaft of the first support roller is established movably against the first driving roller.

Furthermore, the pay-off unit comprises: a bobbin on which the optical fiber is wound; a bobbin motor rotating the bobbin; a decelerator decreasing the rotational force of the bobbin motor; and a first sensor for detecting an amount of the optical fiber wound on the bobbin, and the controller controls the operation of the pay-off unit based on a detection signal of the first sensor.

In addition, a traversing unit adjusting an inlet angle of the optical fiber introduced into the take-up unit is further provided in front of the take-up unit, and the traversing unit comprises: a second guide roller, established on a transfer path of the optical fiber supplied to the take-up unit and guiding the transfer of the optical fiber; and a cam motor reciprocating the second guide roller in a direction perpendicular to the transfer direction of the optical fiber.

Additionally, the controller adjusts a movement distance of the second guide roller to selectively connect the second guide roller to the optical fiber.

Moreover, the cutting unit comprises: a rotational cutter; a second driving motor driving the rotational cutter; and a cutting support established in the rotational direction of the rotational cutter, and the top surface of the cutting support is formed inclined.

Furthermore, a guiding unit guiding the optical fiber drawn from the feeding unit to the take-up unit is further included.

In addition, first and second rails of the guiding unit are connected spaced from each other to form a guide groove on the top thereof and elastic springs are arranged between the first and second rails at regular intervals so as to adjust the spacing interval thereof.

Additionally, the take-up unit comprises: a winding wheel including an upper piece and a lower piece of a semicircular shape connected spaced from each other; a third driving motor rotating the winding wheel; a discharger separating the optical fiber roll wound on the winding wheel from the winding wheel; and a first actuator operating the discharger in a direction horizontal to the winding wheel, a clamp provided in the middle portion of the upper and lower pieces and fixing the optical fiber introduced into an inlet groove is included, the clamp is configured to operate in connection with the movement of the discharger, and a groove for a taping process is provided on the upper sides of the winding wheel and the discharger.

Moreover, the tape supply unit comprises: a tape holder for rotatably mounting a tape roll; and a tape supplier for drawing the tape from the tape holder and providing the same to the taping unit, the tape supplier comprises: a second driving roller and a second support roller for drawing the tape from the tape roll; a dancer rotating in accordance with a tension of the tape supplied to the taping unit; a second sensor for detecting a rotational position of the dancer; and a third driving motor for driving the driving roller, and the controller controls the operation of the third driving motor based on a detection signal of the second sensor.

Furthermore, a third sensor for detecting a minimum rotational position of the dancer is further included, and the controller stops the overall operation of the apparatus if the position of the dancer is detected by the third sensor.

In addition, the second sensor is established so as to vary the position thereof in the horizontal direction.

Additionally, the taping unit comprises: a taping means performing a taping process for the optical fiber roll wound by the take-up unit; a second actuator driving the taping means; a support body to which the taping means and the second actuator are coupled; and a third actuator driving the support body in the up and down direction.

Moreover, the taping means comprises: first to third shafts driven by the second actuator; a tape inlet portion for introducing the tape supplied from the tape supply unit; a tape fixing portion, operated in connection with the first shaft, for catching the tape being introduced through the tape inlet portion and fixing the same, if the first shaft is driven in a first direction; a tape cutting portion, operated in connection with the second shaft, for performing processes of tape-pressing and cutting the optical fiber roll, if the second shaft is drive in a second direction that is opposite to the first direction; a tape stopper, operated in connection with the third shaft, for stopping the transfer of the tape being introduced through the tape inlet portion, if the third shaft is drive in the second direction; and a main body to which the tape fixing portion, the tape cutting portion and the tape stopper are coupled.

Furthermore, the main body makes an n-letter shape generally in a state where the tape fixing portion is coupled thereto.

In addition, an optical fiber roll transfer device for receiving the optical fiber roll discharged form the take-up unit and loading the same on a loading device.

### BRIEF DESCRIPTION OF THE DRAWINGS

The above and other features of the present invention will be described with reference to certain exemplary embodiments thereof illustrated the attached drawings in which:

FIG. 1 is a perspective view showing an outer appearance of an optical fiber rewinding apparatus in accordance with a preferred embodiment of the present invention;

FIG. 2 is a front view of the optical fiber rewinding apparatus shown in FIG. 1 ;

FIG. 3 is a plan view of the optical fiber rewinding apparatus shown in FIG. 1 ;

FIG. 4 is a side view of the optical fiber rewinding apparatus shown in FIG. 1 ;

FIG. 5 is a perspective view showing an outer appearance of an optical fiber feeding unit 30 of FIG. 1;

FIG. 6 is an exploded perspective view showing the optical fiber feeding unit 30;

FIG. 7 is a partial cross sectional view showing a state where the optical fiber feeding unit 30 is connected to a front panel 2;

FIG. 8 is a perspective view showing an outer appearance of an optical fiber cutting unit 50 of FIG. 1;

FIG. 9 is an exploded perspective view of the optical fiber cutting unit 50;

FIG. 10 is a partial cross sectional view showing a state where the optical fiber cutting unit 50 is connected to the front panel 2;

FIG. 11 is a perspective view showing an outer appearance of an optical fiber guiding unit 40 of FIG. 1;

FIG. 12 is an exploded perspective view of the optical fiber guiding unit 40;

FIG. 13 is a perspective view showing an outer appearance of a traversing unit 60 of FIG. 1;

FIG. 14 is an exploded perspective view of the traversing unit 60;

FIG. 15 is a partial cross sectional view showing a state where the traversing unit 60 is connected to the front panel 2;

FIG. 16 is a perspective view showing an outer appearance of a take-up unit 70 of FIG. 1;

FIG. 17 is an exploded perspective view of the take-up unit 70;

FIG. 18 is a partial cross sectional view showing a state where the take-up unit 70 is connected to the front panel 2;

FIG. 19 is perspective view showing an outer appearance of a tape supply unit 80 of FIG. 1;

FIG. 20 is an exploded perspective view of the tape supply unit 80;

FIG. 21 is a partial cross sectional view showing a state where the tape supply unit 80 is connected to the front panel 2;

FIG. 22 is perspective view showing an outer appearance of a taping unit 90 of FIG. 1;

FIG. 23 is an exploded perspective view of the taping unit 90;

FIG. 24 is a partial cross sectional view showing a state where the taping unit 90 is connected to the front panel 2;

FIG. 25 is an exploded perspective view of an optical fiber taper 91 of FIGS. 22 to 24;

FIG. 26 is a partial cross sectional view of the optical fiber taper 91;

FIG. 27 is a perspective view showing an overall outer appearance of an optical fiber rewinding apparatus including an optical fiber loading device 200 and an optical fiber roll transfer device 300; and

FIGS. 28 to 30 are diagrams illustrating an operation of an optical fiber rewinding apparatus in accordance with the present invention;

### DETAILED DESCRIPTION OF THE INVENTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

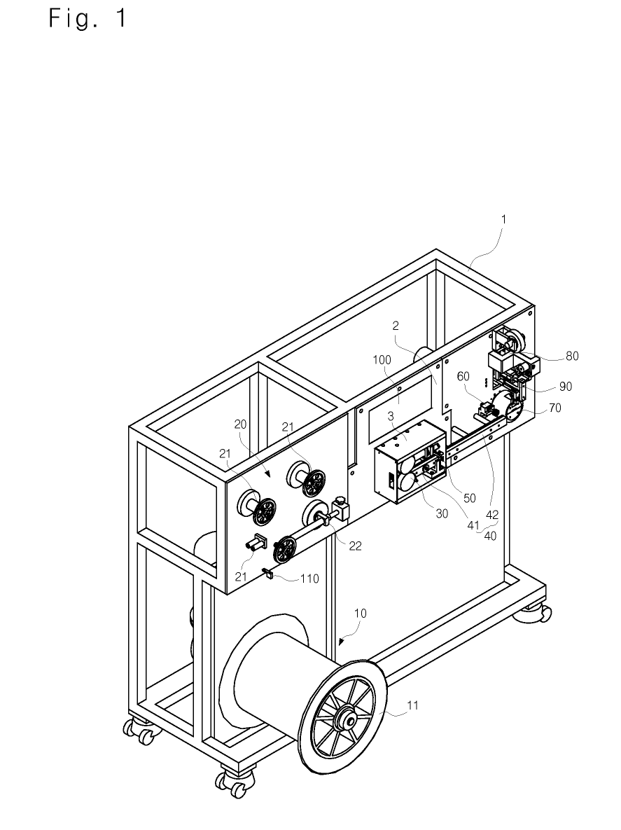

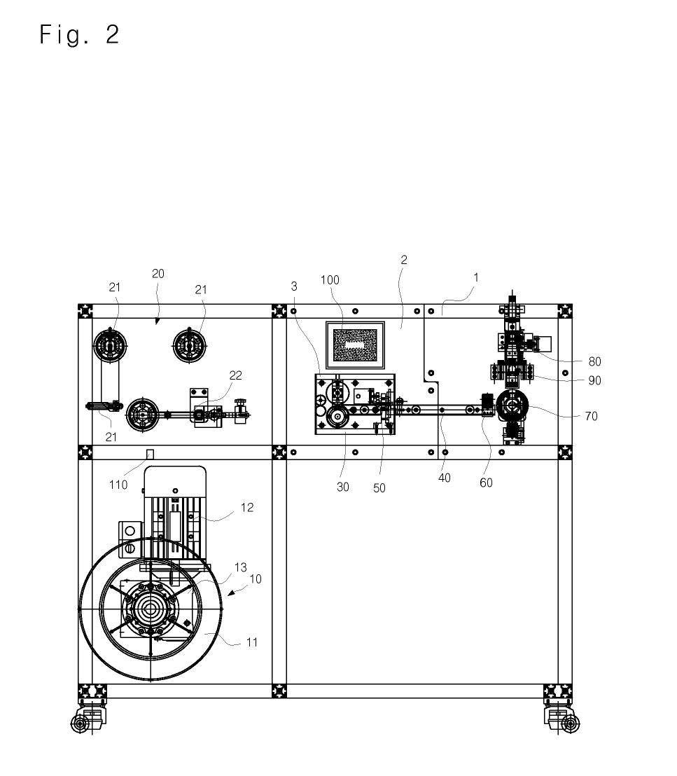

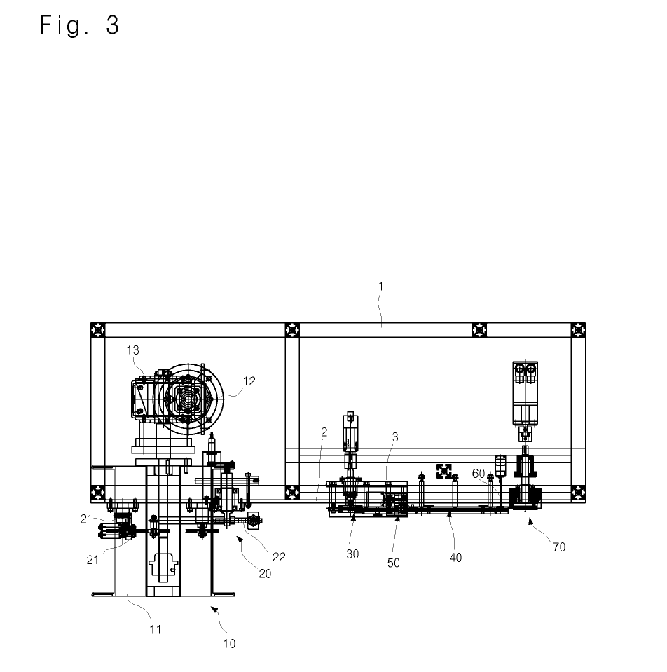

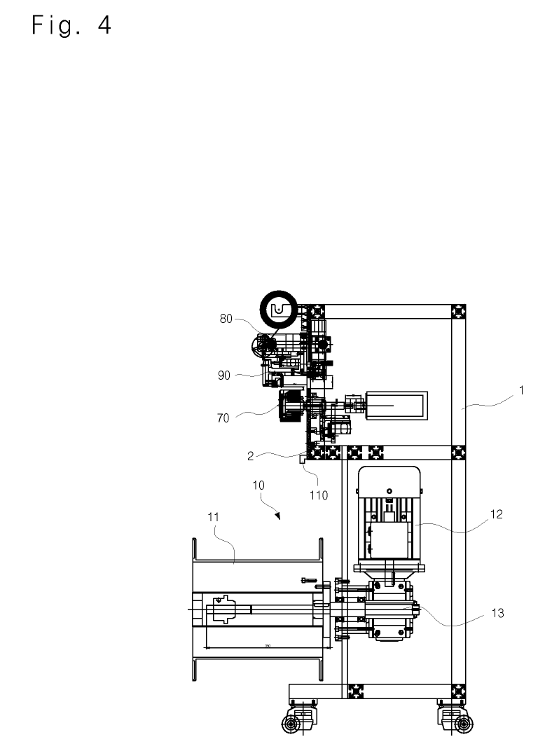

FIG. 1 is a perspective view showing an outer appearance of an optical fiber rewinding apparatus in accordance with a preferred embodiment of the present invention. FIG. 2 is a front view of the apparatus shown in FIG. 1, FIG. 3 is a plan view thereof, and FIG. 4 is a side view thereof.

An optical fiber rewinding apparatus in accordance with the present invention broadly comprises a pay-off unit 10 supplying optical fiber to be rewound, a cutting unit 50 cutting the optical fiber supplied from the pay-off unit 10 in a predetermined length, a take-up unit 70 winding the optical fiber supplied from the pay-off unit 10, a tape supply unit 80 supplying tape for taping an optical fiber roll, and a taping unit 90 taping the optical fiber roll rewound by the take-up unit 70.

Moreover, a tension adjusting unit 20 for maintaining a tension of the optical fiber supplied to the cutting unit 50 at a constant level and a feeding unit 30 for feeding the optical fiber to the take-up unit 70 through the cutting unit 50 are provided between the pay-off unit 10 and the cutting unit 50. Furthermore, a guiding unit 40 guiding the optical fiber supplied to the take-up unit 70 and a traversing unit 60 adjusting the winding position of the optical fiber in the take-up unit 70 appropriately are provided between the cutting unit 50 and the take-up unit 70.

The respective units described above are provided fixedly on a front panel 2 of a frame 1 in the apparatus and the feeding unit 30 and the cutting unit 50 are provided on the front panel 2 through a receiving box 3 provided in consideration of the safety of workers.

Moreover, a control panel 100 through which the worker controls the operation of the apparatus is provided at a predetermined position of the front panel 2. The control panel 100 is composed of a touch screen, for example. The control panel 100 includes an on/off key for turning on/off the operation of the apparatus, an emergency key for stopping the operation of the apparatus in case of emergency, and an input key for inputting process information such as the kind of the optical fibers to be rewound, that is, whether the optical fiber to be rewound is a single-core optical fiber or a multi-core optical fiber, an amount of the optical fiber, a length of the optical fiber to be rewound, and the like. The process information input through the control panel 100 is provided to a controller, not depicted, and the controller controls the overall operation of the apparatus based on the process information input through the control panel 100.

The pay-off unit 10 includes a bobbin 11 on which the optical fiber is wound, a bobbin motor 12 rotating the bobbin 11 and a decelerator 13 decelerating the bobbin motor 12. Moreover, an ultrasonic sensor 110 for detecting the amount of the optical fiber being wound on the bobbin 11 is provided on the front panel 2 over the bobbin 11. The amount of the optical fiber drawn from the bobbin 11 when the bobbin 11 rotates one time is varied according to the amount of the optical fiber being wound on the bobbin 11. The controller controls the driving of the bobbin motor 12 to be turned on/off and further adjusts the driving speed of the bobbin motor 12 appropriately based on data detected by the ultrasonic sensor 110.

Moreover, the tension adjusting unit 20 includes a guide roller 21 and a dancer 22 for the tension adjustment. The tension adjusting unit 20 is the same one used in an ordinary winding apparatus.

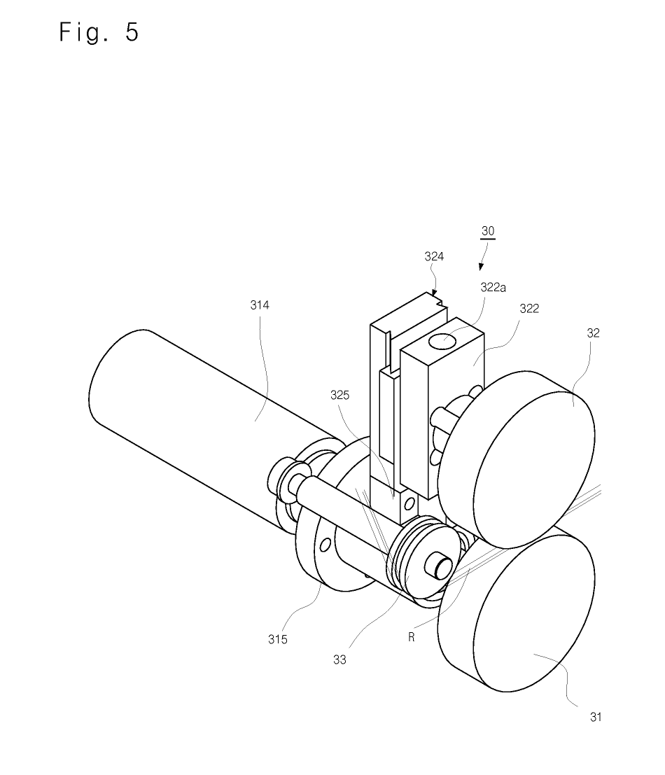

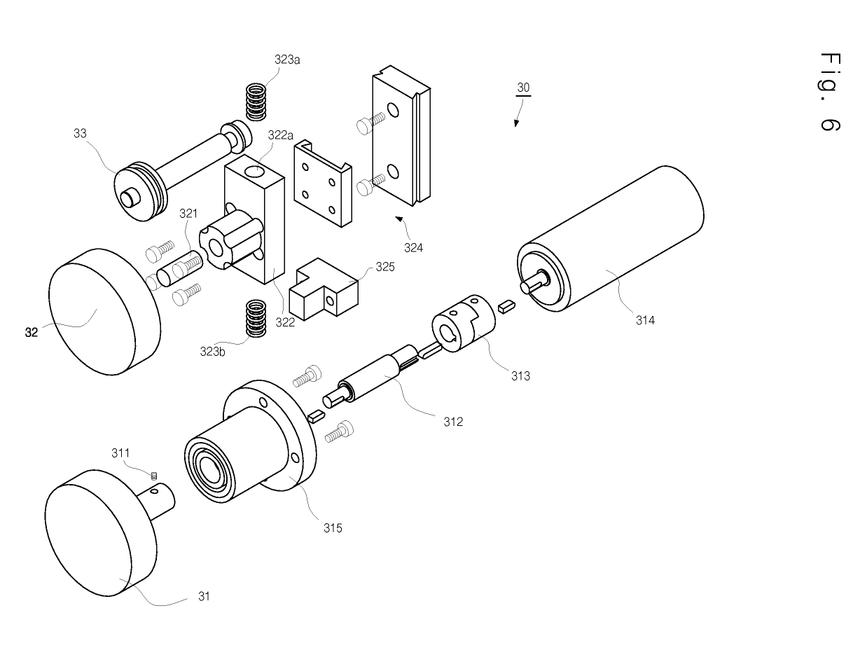

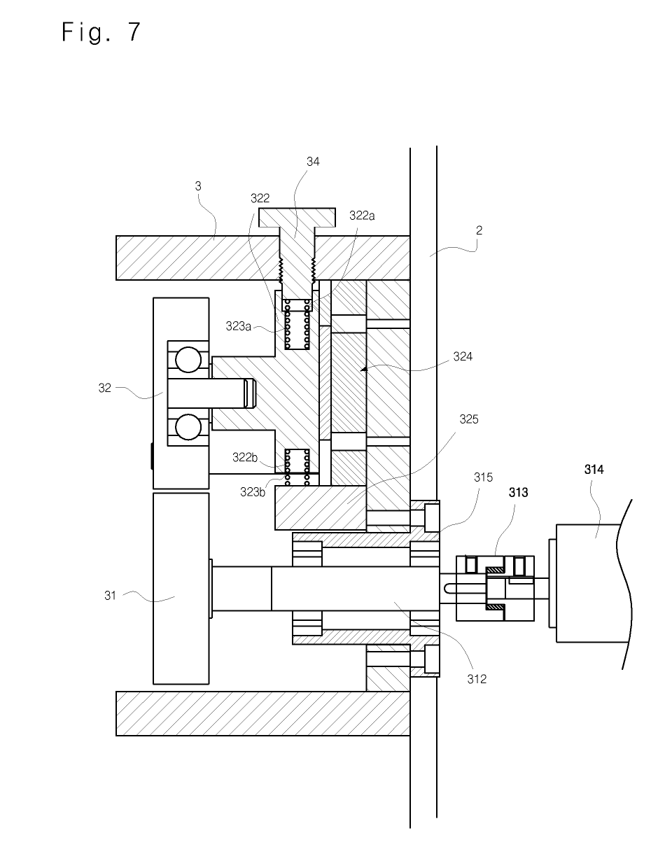

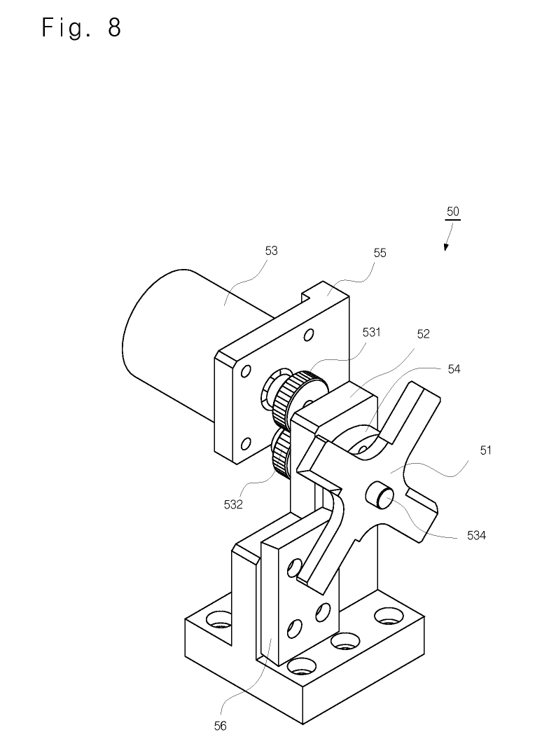

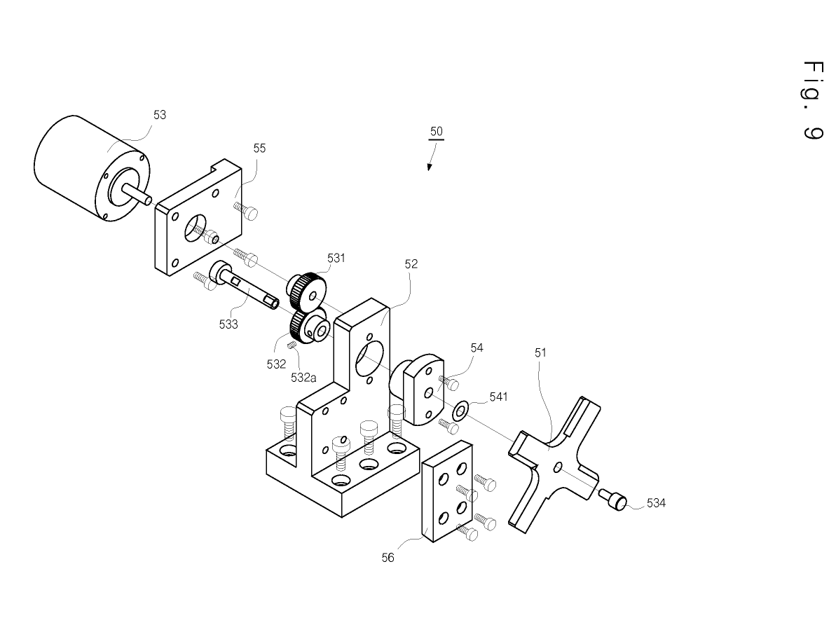

FIG. 5 is a perspective view showing an outer appearance of the optical fiber feeding unit 30 received in the receiving box 3, FIG. 6 is an exploded perspective view thereof, and FIG. 7 is a partial cross sectional view showing a state where the optical fiber feeding unit 30 is mounted in the receiving box 3 on the front panel 2.

The feeding unit 30 includes a driving roller 31, a support roller 32 and a guide roller 33. The driving roller 31 is connected to a shaft 312 by means of a screw 311, and the shaft 312 is coupled to a driving motor 314 through a coupling 313. The shaft 312 is supported rotatably on the front panel 2 through a bearing 315. At this time, the operation of the driving motor 314 is controlled by the controller.

The support roller 32 is connected rotatably to a support bracket 322 through a shaft 321, and the support bracket 322 is connected slidably up and down to the receiving box 3 through a sliding member 324. The guide roller 33 guide the optical fiber R drawn through the tension adjusting unit 20 to be smoothly led between the driving roller 31 and the support roller 32.

Especially, the support bracket 322 includes insertion grooves 322a and 322b through which elastic springs 323a and 323b are inserted. The elastic spring 323a is supported by a rotation lever 34 provided on the top of the receiving box 3 and the elastic spring 323b is supported by a holding stand 325 provided on the bottom of the support bracket 322. With the elastic springs 323a and 323b, the driving roller 31 and the support roller 32 come into close contact with each other at a predetermined pressure regardless of the thickness of the optical fiber drawn between the driving roller 31 and the support roller 32. Here, the contact force between the driving roller 31 and the support roller 32 is appropriately adjusted by the rotation lever 34.

Subsequently, the optical fiber drawn from the feeding unit 30 is supplied to the take-up unit 70 through the guiding unit 40 including first and second guides 41 and 42 as shown in FIG. 1. Here, the cutting unit 50 for cutting the optical fiber is placed between the first and second guides 41 and 42.

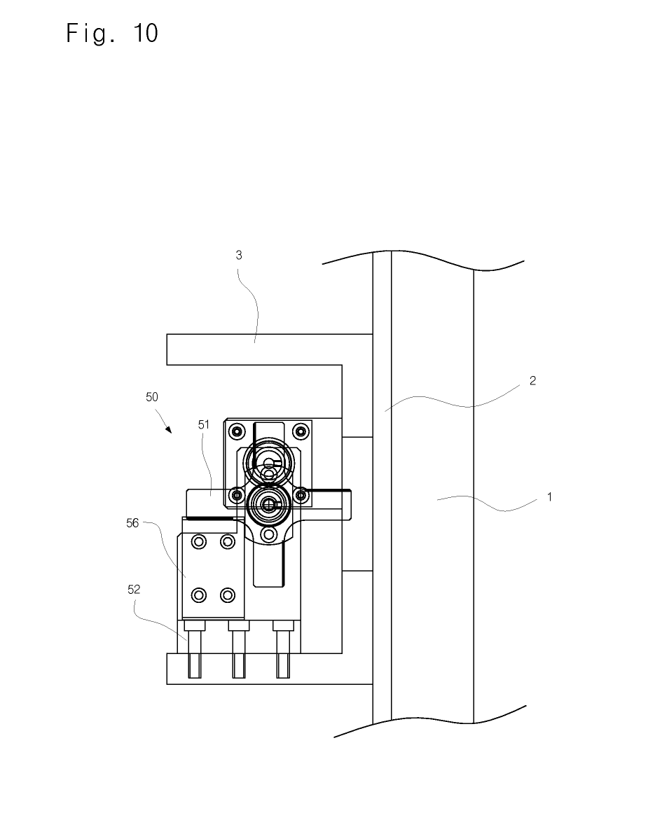

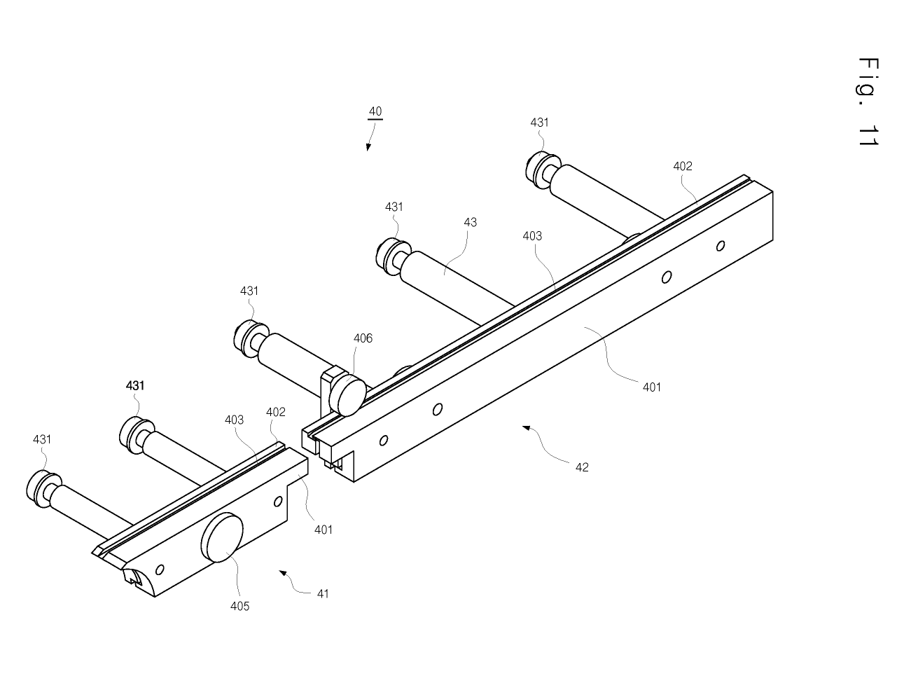

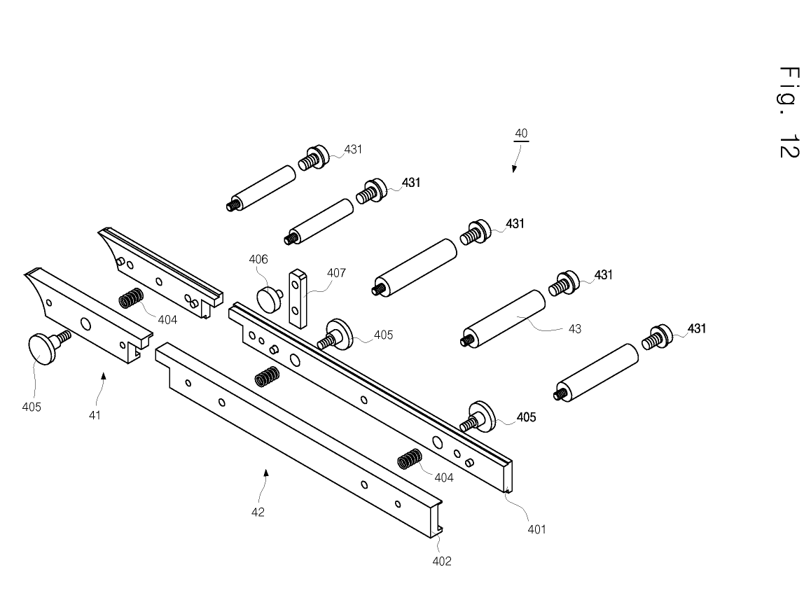

FIG. 8 is a perspective view showing an outer appearance of the cutting unit 50, FIG. 9 is an exploded perspective view thereof, and FIG. 10 is a partial cross sectional view showing a state where the cutting unit 50 is mounted in the receiving box 3 on the front panel 2.

The cutting unit 50 includes a rotational cutter 51, a support body 52 and a driving motor 53. The driving motor 53 is composed of a step motor, for example, and controlled by the controller. The controller controls the cutting operation of the optical fiber by rotating the driving motor 53 at 90 degrees.

The rotational cutter 51 is connected closely to one side of a bearing 54 through a washer 541. Here, the washer 541 supports the rotational cutter 51 rotatably to the bearing 54 and is used to adjust the space between the rotational cutter 51 and the bearing 54.

The driving motor 53 is connected to the receiving box 3 through a bracket 55. A driving gear 531 is coupled to a motor shaft of the driving motor 53. A follower gear 532 is engaged with the driving gear 531 and a follower gear shaft 533 is connected to the follower gear 532 by means of a screw 532a. The follower gear shaft 533 is supported rotatably on the support body 52 by the bearing 54 and connected to the rotational cutter 51 by means of a connection member 534.

Meanwhile, a cutting support 56 is provided in the rotational direction of the rotational cutter 51. The cutting process of the optical fiber is made by the interlock of the cutting support 56 and the rotational cutter 51. The height of the top surface of cutting support 56 is set at the same height as the first and second guides 41 and 42 so that the optical fiber passing through the cutting unit 50 can maintain its level state. Moreover, the top surface of the cutting support 56 is inclined at a predetermined angle and thereby the height of a side adjacent to the rotational cutter 51 is set greater than that of the opposite side. Accordingly, the top surface of the cutting support 56 functions as a horizontal blade when the rotational cutter 51 rotates to cut the optical fiber. Such a cutting structure facilitates the cutting process of the optical fiber and minimizes noise generated during the optical fiber cutting process.

FIG. 11 is a perspective view showing an outer appearance of the guiding unit 40, and FIG. 12 is an exploded perspective view thereof.

The guiding unit 40 includes the first guide 41 and the second guide 42. These first and second guides 41 and 42 are substantially in the same structure. First and second rails 401 and 402 of the first and second guides 41 and 42 are connected spaced from each other to form a guide groove 403 on the top thereof. Especially, elastic springs 404 are arranged between the first and second rails 401 and 402 at regular intervals, and bolts 405 are inserted into the elastic springs 404 to connect the first and second rails 401 and 402. Accordingly, if rotating the bolts 405 in a clockwise or counterclockwise direction, the space between the first and second rails 401 and 402 is changed to adjust the width of the guide groove 403, which is for the purpose of adjusting the width of the guide groove 403 in accordance with the kind of the optical fibers transferred through the guiding unit 40.

Moreover, a guide roller 406 for preventing the optical fiber being transferred through the guide groove 403 from being separated from the guide groove 403 is provided at a predetermined position of the top surface of the second guide 42. The guide roller 406 is connected rotatably to a support member 407 coupled to one side of the first rail 401. Furthermore, guide support bars 43 are screw-connected to the side of the first rail 401 and connected to the rear of the receiving box 3 and the front panel 2 by means of bolts 431.

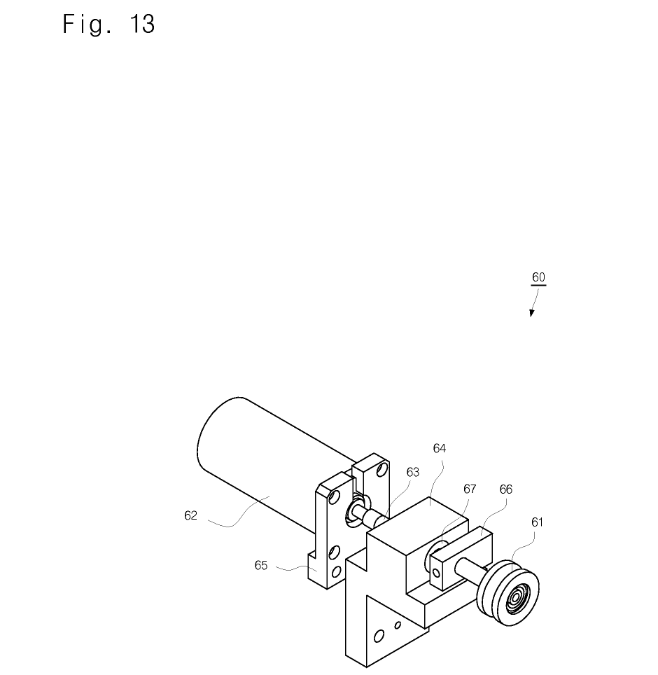

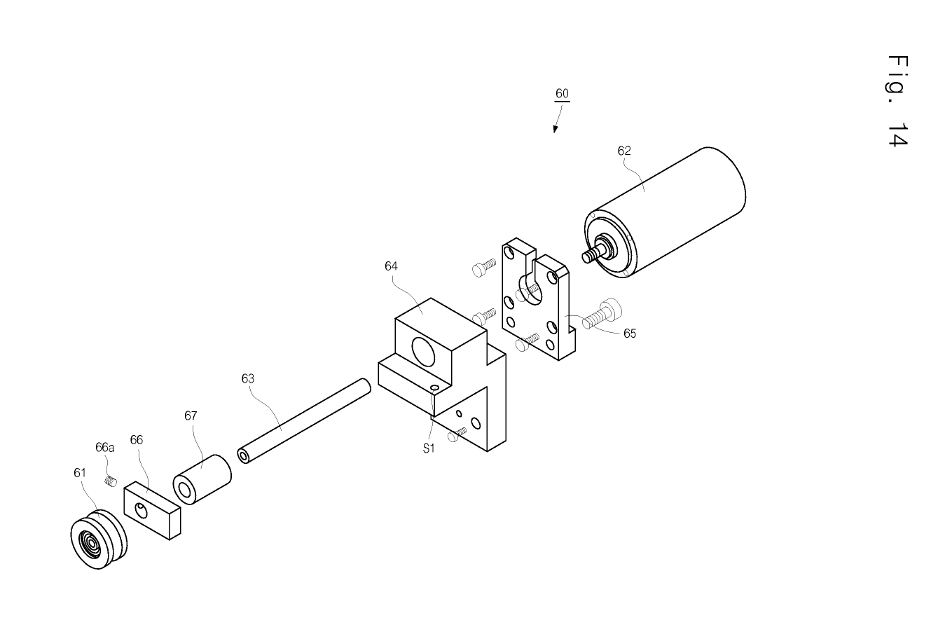

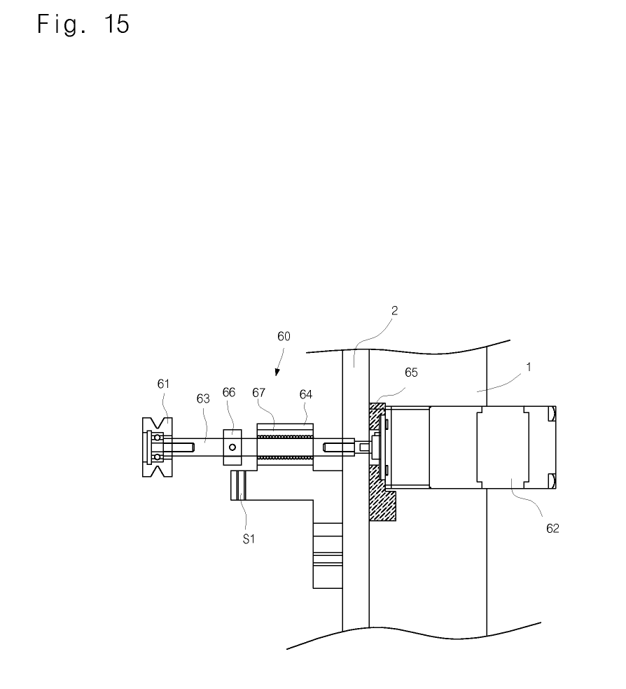

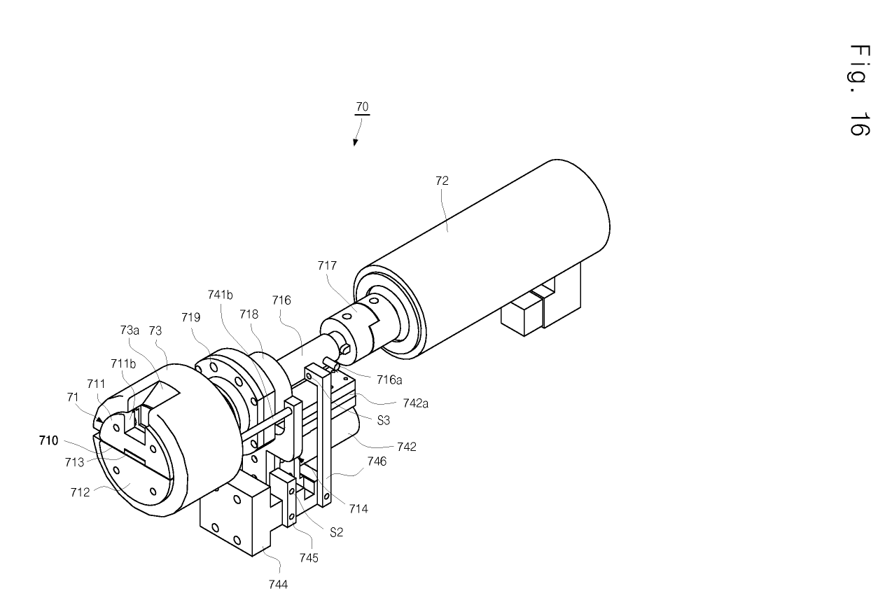

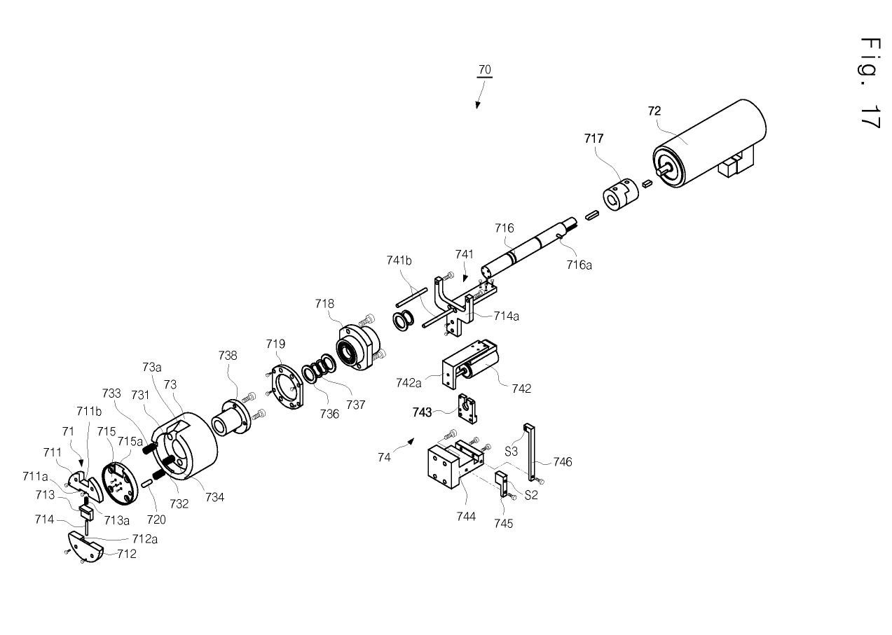

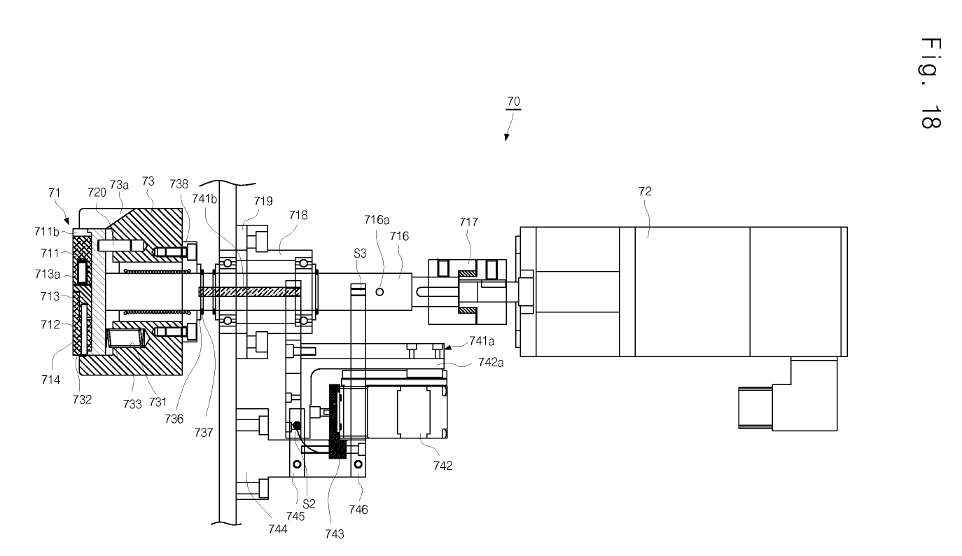

FIG. 13 is a perspective view showing an outer appearance of the traversing unit 60, FIG. 14 is an exploded perspective view thereof, and FIG. 15 is a partial cross sectional view showing a state where the traversing unit 60 is provided on the front panel 2.

The traversing unit 60 includes a guide roller 61 for guiding the winding position of the optical fiber to be supplied to and wound by the take-up unit 70 (to be described later) and a cam motor 62 reciprocating the guide roller 61 in a direction perpendicular to the transfer direction of the optical fiber.

The guide roller 61 and the cam motor 62 are connected to each other through a shaft 63, and the shaft 63 is connected to and supported by a support body 64 through a bush 67. The cam motor 62 is connected to the front panel 2 through a bracket 65. The operation of the cam motor 62 is controlled by the controller. If a traversing function is not required, that is, if the optical fiber to be wound by the take-up unit 70 is a multi-core optical fiber, i.e., a ribbon optical fiber, the controller controls the cam motor 62 to move the guide roller 61 to the side of the support body 64, thus forwarding the optical fiber introduced through the guide unit 40 directly to the take-up unit 70. If the traversing function is required, that is, if the optical fiber to be wound by the take-up unit 70 is a signal-core optical fiber, the controller controls the cam motor 62 to move the guide roller 61 to the outside of the support body 64, thus supplying the optical fiber introduced through the guide unit 40 through the guide roller 61 to the take-up unit 70. Moreover, in this case, the controller reciprocates the guide roller 61 in a direction perpendicular to the transfer direction of the optical fiber at the same time when the take-up unit 70 is operated, thus leveling the winding surface of the optical fiber to be wound by the take-up unit 70. Of course, the kind of the optical fiber to be wound by the take-up unit 70 is set through the control panel 100 shown in FIG. 1 by the worker.

Meanwhile, a sensing member 66 is connected to the shaft 63 between the support body 64 and the guide roller 61 by means of a screw 66a, and a sensor S1 for detecting the sensing member 66 is provided on an upper side of the support body 64 corresponding to the sensing member 66. The sensor S1 is composed of an optical sensor, for example. The controller detects the sensing member 66 through the optical sensor S1 to initiates the position of the guide roller 61.

FIG. 16 is a perspective view showing an outer appearance of the take-up unit 70, FIG. 17 is an exploded perspective view thereof, and FIG. 18 is a partial cross sectional view showing a state where the take-up unit 70 is provided on the front panel 2.

The take-up unit 70 includes a winding wheel 71 for winding the optical fiber supplied from the guiding unit 40 or from the traversing unit 60, a driving motor 72 rotatably driving the winding wheel 71, a discharger 73 for discharging an optical fiber roll wound on the winding wheel 71 from the winding wheel 71, and a discharger operating unit 74 operating the discharger 73 in a direction horizontal to the winding wheel 71.

The winding wheel 71 includes an upper piece 711 and a lower piece 712 having a semicircular section. Here, the upper piece 711 and the lower piece 712 are spaced from each other at regular interval to form an inlet groove 710 for introducing the optical fiber. A receiving groove 711a for receiving a clamp 713 is formed in the lower middle portion of the upper piece 711.

The clamp 713 is elastically supported on the receiving groove 711a of the upper piece 711 through an elastic member 713a. An operation pin 714 for pushing up the clamp 713 is provided on the lower side of the clamp 713. The operation pin 714 is operated downward by an accommodating groove 732 included in the discharger 73 (to be described later), thus moving the clamp 713 downward. At this time, the optical fiber introduced through the inlet groove 710 is caught on the lower piece 712 by the clamp 713.

Moreover, a groove 711b is provided on the upper side of the upper piece 711 to facilitate a taping process of the taping unit 90 (to be described later).

The winding wheel 71 is connected to a fixing plate 715 by means of a connection member such as a bolt, etc. A groove 715a is provided at a position corresponding to the groove 711b of the upper piece 711 on the upper side of the fixing plate 715. The fixing plate 715 is connected to a shaft 716 by means of a connection member such as a bolt, etc., and the shaft 716 is coupled to a driving shaft of the driving motor 72 through a coupling 717. The operation of the driving motor 72 is controlled by the controller. Moreover, the fixing plate 715 is connected to the discharger 73 by means of a connection pin 720 and thereby the discharger 73 is rotated along with the fixing plate 715 being rotated by the driving motor 72.

A bearing 718 is coupled to the shaft 716. The bearing 718 is connected to the front panel 2 through an insertion member 719 for adjusting the spacing interval to support the shaft 716 rotatably to the front panel 2.

The discharger 73 includes a circular receiving portion 731 for receiving the winding wheel 71 and the fixing plate 715 provided in front thereof. The size of the receiving portion 731 is set to a size that can provide a rotational degree of freedom of the winding wheel 71 and discharge the optical fiber roll wound on the winding wheel 71 from the winding wheel 71 to the outside when the discharger 73 is moved to the side of the winding wheel 71. Moreover, the accommodating groove 732 for moving the operation pin 714 of the winding wheel 71 downward is provided at a position corresponding to the operation pin 714 on the inner circumference of the receiving portion 731 as described above. Furthermore, a receiving groove 734 for receiving elastic members 733 and an accommodating groove, not depicted, for accommodating the connection pin 720 described above are included in the receiving portion 731.

The discharger 73 is elastically supported on the winding wheel fixing plate 715 by the elastic members 733 included in the receiving portion 731, and its position is set on the shaft 716 by means of O-rings 736 and C-clips 737.

Moreover, a bush 738 for supporting the discharger 73 operatably to the shaft 716 is provided in the middle portion of the discharger 73, and a groove 73a is provided at a position corresponding to the groove 711b of the winding wheel 71 on the upper side of the discharger 73. The groove 73a is also to facilitate the taping process for the optical fiber roll wound on the winding wheel 71.

The discharger operating unit 74 includes an operation member 741 for pushing the discharger 73 toward the winding wheel 71 and an actuator 742 for driving the operation member 741 in the axial direction of the shaft 716. The operation of the actuator 742 is controlled by the controller.

The operation member 741 includes an operation plate 741a connected to a driving plate 742a by means of a connection member such as a bolt, etc., and a shaft 741b of which one end is connected to the operation plate 741a by means of a connection member such as a bolt, etc. and the other end is directed toward the discharger 73.

The actuator 742 is connected to a support body 744 through a bracket 743, and the support body 744 is coupled to the front panel 2 by means of a connection member such as a bolt, etc.

Sensors S2 and S3 are established on one side of the support body 744 through support stands 745 and 746. These sensors S2 and S3 are composed of an optical sensor, for example, and electrically connected to the controller through conductive wires, not depicted. Here, the sensor S2 is arranged adjacent to one side of the driving plate 742a to detect the position of the driving plate 742a. The detection result is used by the controller to initiate the operation position of the actuator 742. The sensor S3 detects the position of a projection 716a positioned on the shaft 716 and the detection result is used to initiate the position of the driving motor 72, more accurately, the rotational position of the winding wheel 71.

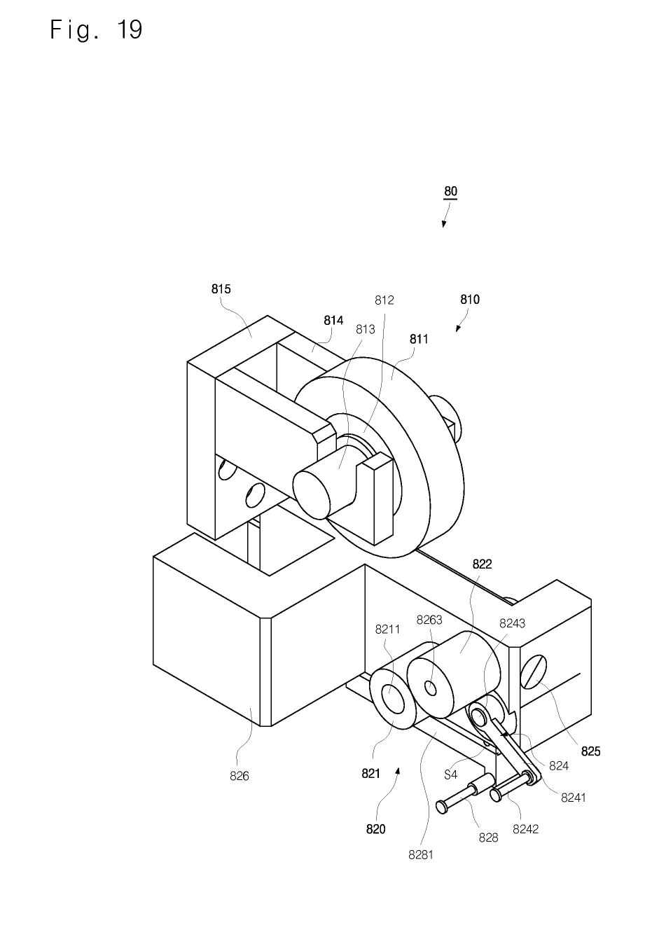

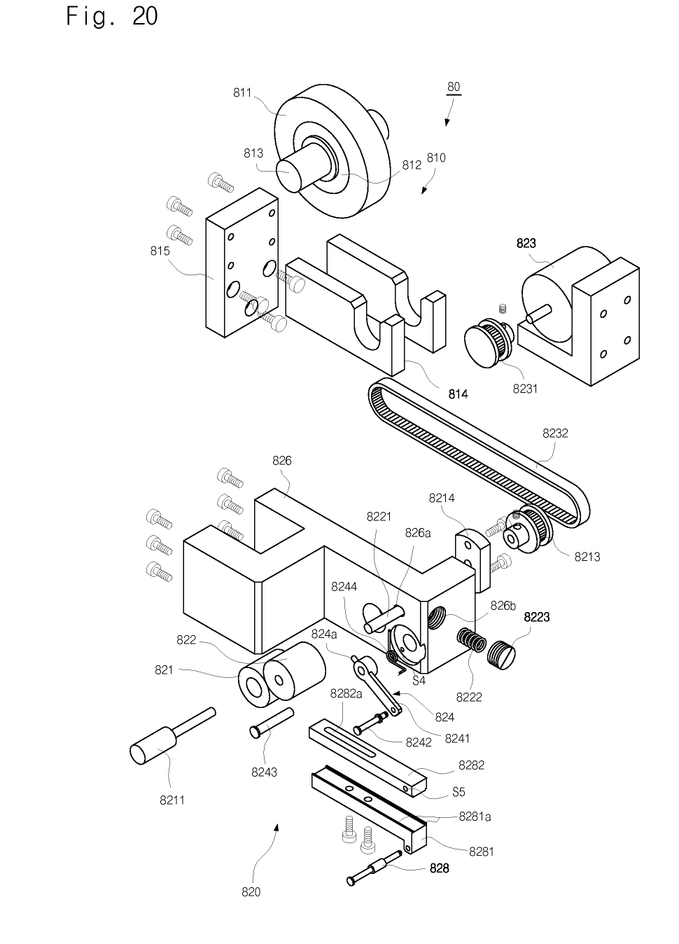

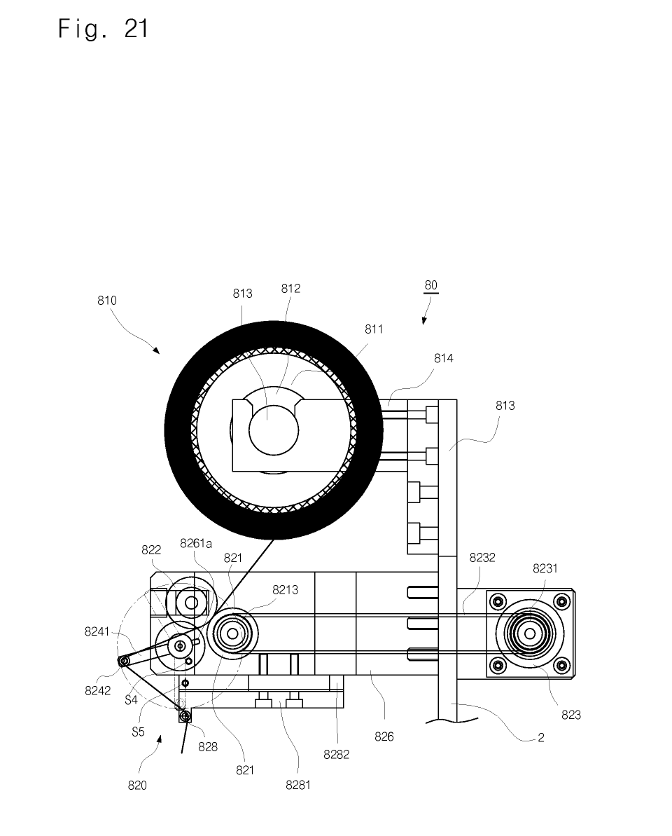

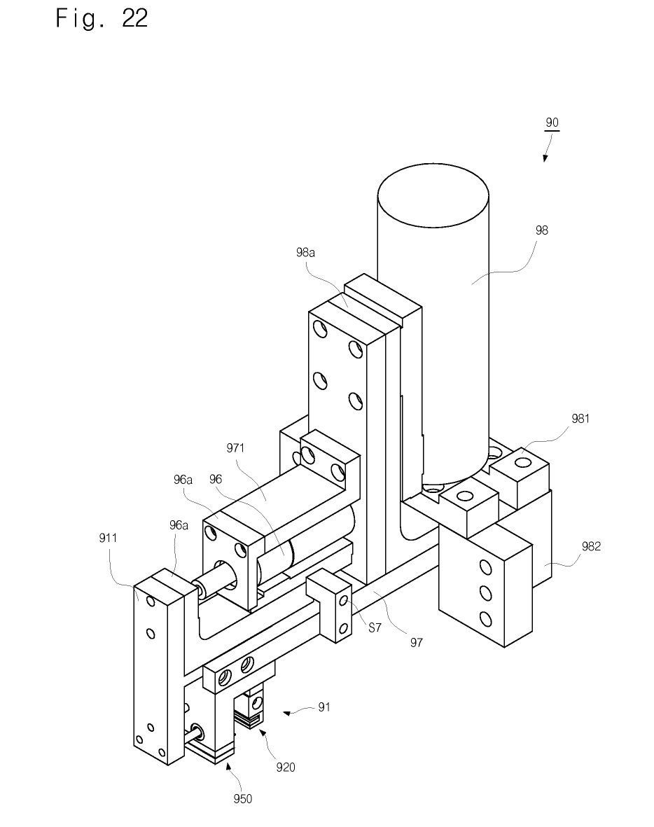

FIG. 19 is perspective view showing an outer appearance of the tape supply unit 80, FIG. 20 is an exploded perspective view thereof, and FIG. 21 is a partial cross sectional view showing a state where the tape supply unit 80 is provided on the front panel 2.

The tape supply unit 80 includes a tape holder 810 for mounting a tape roll to be rotated and a tape supplier 820 drawing the tape from the tape holder 810 and supplying the same to the taping unit 90.

The tape holder 810 includes a circular reel 811 on which the tape roll is mounted. The reel 811 is connected to a reel axis 813 through a bearing 812, and the reel axis 813 is held detachably on holding stands 814. The holding stands 814 are connected at a predetermined position of the front panel 2 through a bracket 815.

The tape supplier 820 includes a driving roller 821 for drawing the tape from the tape holder 810, a support roller 822 therefor, a driving motor 823 driving the driving roller 821, a dancer 824 rotated up and down in accordance with the tension of the tape supplied to the taping unit 90. The tape drawn through the dancer 824 is supplied to the taping unit 90 through a guide bar 828. The above respective devices are connected to the front panel 2 through a support body 826.

The driving roller 821 is connected to a timing gear 8213 through a shaft 8211. Here, the shaft 8211 is supported rotatably on the support body 826 by a bearing 8214. Moreover, another timing gear 8231 is coupled to a driving shaft of the driving motor 823. Both the timing gears 8213 and 8231 are connected to each other through a timing belt 8232. The operation of the driving motor 823 is controlled by the controller.

The support roller 822 is connected rotatably to the support body 826 by a shaft 8221. The support roller 822 is placed adjacent to the driving roller 821. Especially, a connection groove 826a to which the shaft 8221 is coupled is made in the form of an ellipse, and a receiving groove 826b is connected to the connection groove 826a in the perpendicular direction. An elastic spring 8222_is received in the receiving groove 826b and then a bolt 8223 is engaged therewith. The bolt 8223 is used to adjust the contact force of the support roller 822 against the driving roller 821 by adjusting the pressure applied to the shaft 8221 by the elastic spring 8222.

The dancer 824 includes a dancer arm 8241 and a guide bar 8242 connected to an end portion of the dancer arm 8241 and guiding the tape drawn through the driving roller 821. The dancer arm 8241 is coupled rotatably to the support body 826 by a connection pin 8243 and, at the same time, elastically supported upward by a tension spring 8244.

Meanwhile, a sensor S4 for detecting the rotational position of the dancer 824 is provided on the left lower side where the dancer 824 is connected to the support body 826, and a sensing projection 824a corresponding to the sensor S4 is provided on the dancer 824. If the tape roll mounted on the tape holder 810 is exhausted and thereby the tape introduced to the tape supplier 820 is cut, the dancer 824 is rotated upward maximally by the tension spring 8244. At this time, the sensor S4 detects the sensing projection 824a and applies the detection signal to the controller. Then, the controller stops the overall operation of the optical fiber rewinding apparatus of the present invention.

The guide bar 828 is coupled to the lower side of the support body 826 through a bracket 8281. A sensor block 8282 is provided on the upper side of the bracket 8281 and connected to the lower side of the support body 826 by means of a connection member such as a bolt, etc. Especially, a guide rail 8281a for guiding the sensor block 8282 is provided on the upper side of the bracket 8281, and a long hole 8282a is formed at a position corresponding to the connection member on the sensor block 8282. According to this, the sensor block 8282 can be moved by a predetermined length along the longitudinal direction of the bracket 8281.

A sensor S5 is provided on one end of the sensor block 8282. The sensor S5 detects the position of the dancer arm 8241 and is composed of an optical sensor, for example. If the tension of the tape supplied from the tape supplier 820 to the taping unit 90 is increased, the dancer arm 8241 is rotated downward, which is detected by the sensor S5. The detection signal of the sensor S5 is applied to the controller and then the controller controls the driving motor 823 based on the detection signal. Of course, the detected position of the dancer arm 8241 may be varied according to the movement of the sensor block 8282 along the longitudinal direction of the bracket 8281.

The tape supply unit 80 is configured in preparation for a case where a tape used in tying the rewound optical roll shows excellent adhesion force for the same material, whereas, it does not adhere to the other material. Accordingly, the configuration of the tape supply unit 80 may be varied or the application may be deferred in accordance with the kind or adhesion force of the tape used in tying the rewound optical fiber roll.

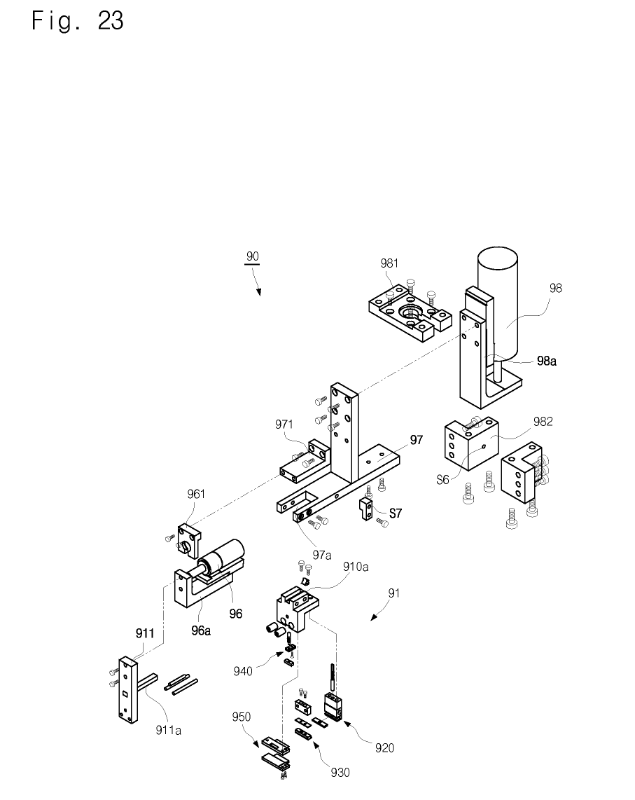

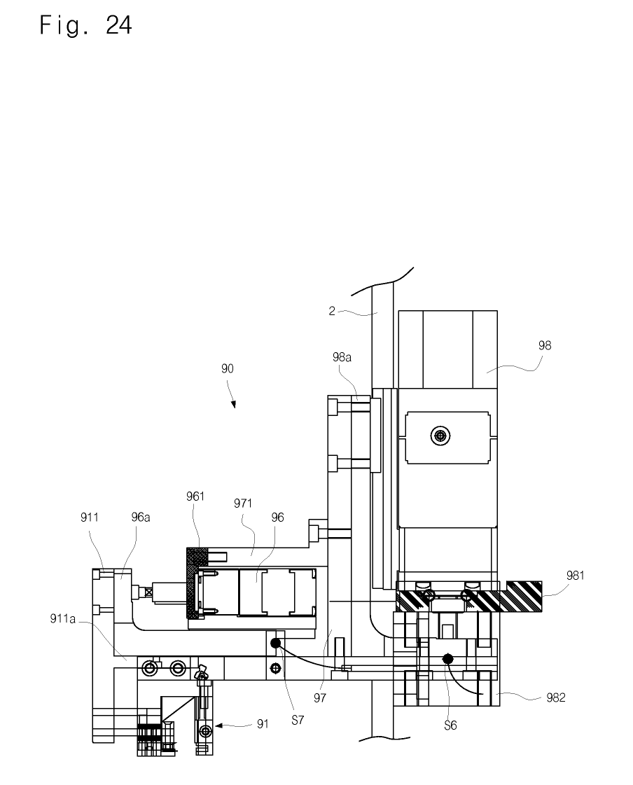

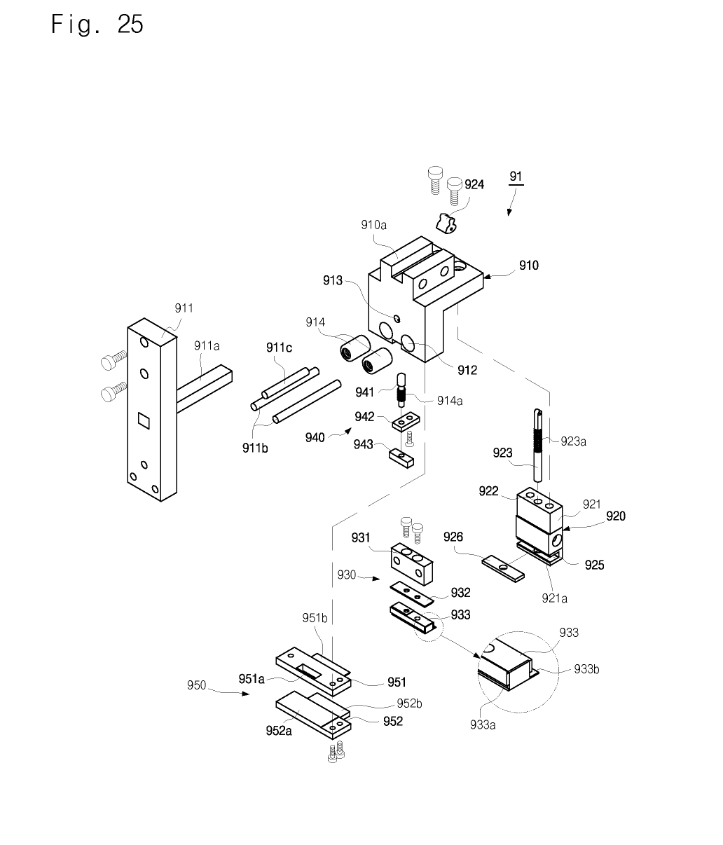

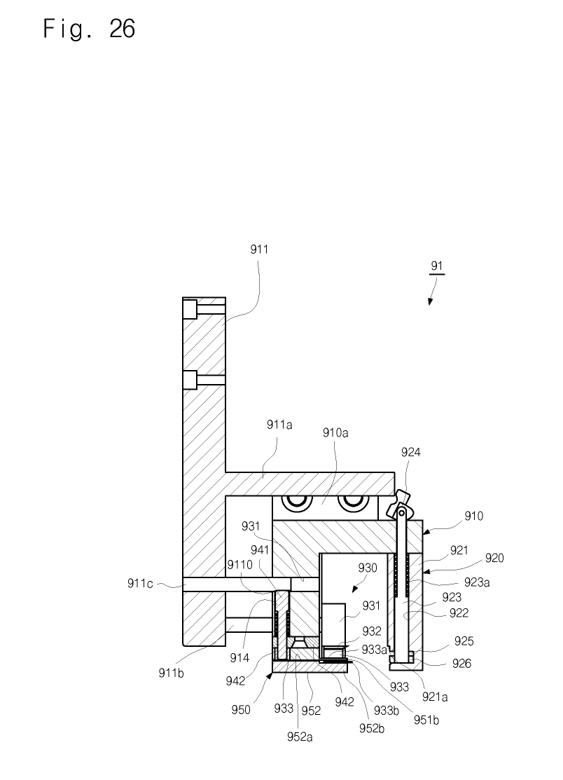

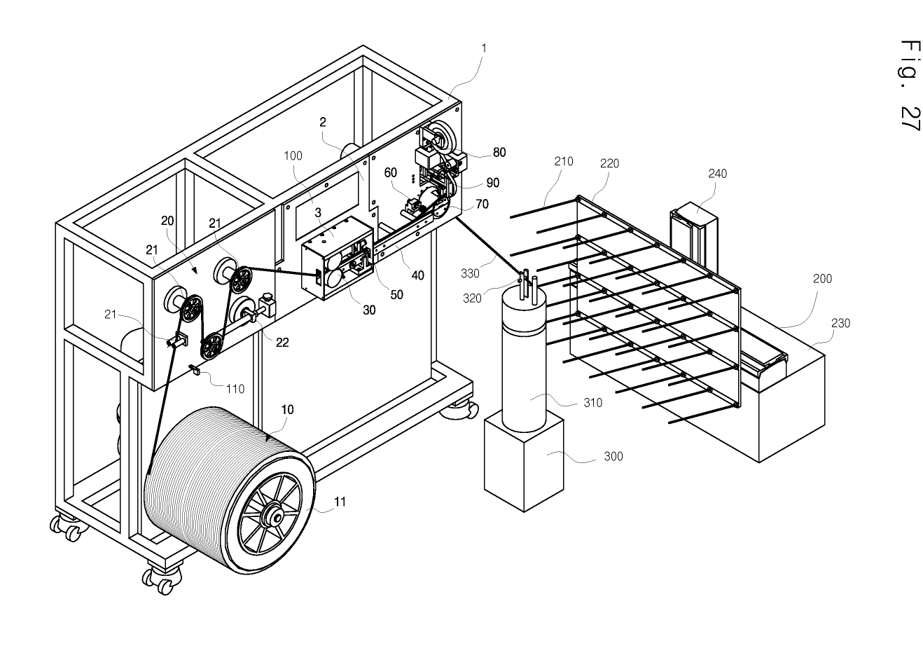

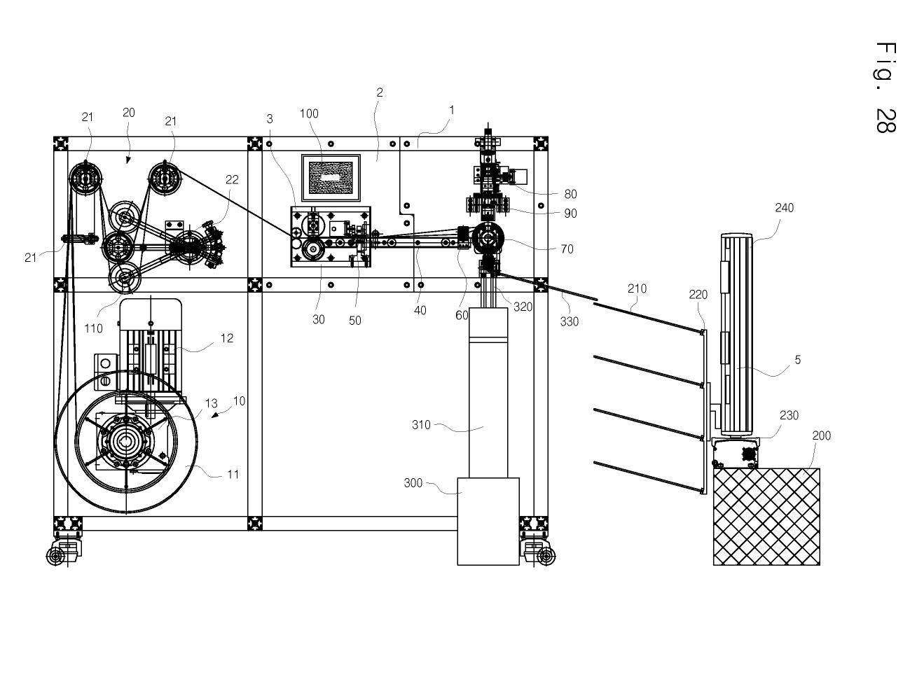

FIG. 22 is perspective view showing an outer appearance of the taping unit 90, FIG. 23 is an exploded perspective view thereof, and FIG. 24 is a partial cross sectional view showing a state where the taping unit 90 is provided on the front panel 2. Moreover, FIG. 25 is an exploded perspective view of an optical fiber taper 91, and FIG. 26 is a partial cross sectional view of the optical fiber taper 91.

The taping unit 90 includes a taper 91 performing a taping process for the optical fiber roll wound on the winding wheel 71 of FIG. 16, an actuator 96 driving the taper 91, and an actuator 98 for driving a support body 97 in the up and down direction on which the taper 91 and the actuator 96 are mounted. Here, the operations of the actuators 96 and 98 are controlled by the controller.

The actuator 98 is connected to a support bracket 982 through a bracket 981, and the support bracket 982 is coupled to the front panel 2 by means of a connection member such as a bolt, etc. A sensor S6 is established on one side of the support bracket 982. The sensor S6 composed of an optical sensor, for example, detects the position of a driving plate 98a. The detection signal of the sensor S6 is applied to the controller and then the controller initiates the position of the actuator 98 based on the detection signal.

The support body 97 is connected to the driving plate 98a of the actuator 98 by means of a bolt, for example. A connection plate 971 is connected to a vertical plate of the support body 97 by means of a bolt, for example. The actuator 96 is coupled to the connection plate 971 through a bracket 961. Moreover, a sensor S7 is provided on one side of the support body 97. The sensor S7 detects the position of a driving plate 96a of the actuator 96. The detection signal of the sensor S7 is applied to the controller and then the controller initiates the position of the actuator 96 based on the detection signal.

As described above, the actuator 96 is to operate the taper 91. A bracket 911 is coupled to the driving plate 96a of the actuator 96 by means of a bolt, for example. First to third driving shafts 911a, 911b and 911c for driving a tape fixing portion 920, a tape cutting portion 930 and a tape stopper 940, respectively, are connected to the bracket 911.

The tape fixing portion 920 catches the end of the tape supplied from the tape supply unit 80 to fix the tape. The tape cutting portion 930 performs a process of taping the optical fiber roll wound on the winding wheel 71 of the take-up unit 70 in connection with the tape fixing portion 920 and then carries out a process of cutting the tape. The tape stopper 940 prevents the tape from being drawn out to the outside through a tape inlet portion 950 when the tape cutting portion 930 is operated and when the taping unit 90 is moved upward after completing the taping process.

The tape fixing portion 920, the tape cutting portion 930 and the tape stopper 940 are connected to a main body 910.

A guide rail 910a guiding the first driving shaft 911a is provided on the top surface of the main body 910. Moreover, a receiving groove 97a is established on one side of the support body 97, through which the guide rail 910a of the main body 910 is inserted and then fixed by means of a bolt, etc. Inlet holes 912 and 913 through which the second and third driving shafts 911b and 911c are inserted are formed on the side of the main body 910. The second driving shafts 911b are supported by bushes 914.

A connection hole 914 connected to the inlet holes 913 is provided on the lower side wall of the main body 910. A stopper shaft 941 is inserted into the connection hole 914 and elastically supported by an elastic spring 941a. A connection plate 942 for preventing the separation of the stopper shaft 941 and supporting the elastic spring 941a is coupled to the lower portion of the connection hole 914. A pressing plate 943 pressing the tape introduced into the tape inlet portion 950 (to be described below) to stop the transfer of the tape is fixed on an end portion of the stopper shaft 941.

The tape inlet portion 950 for introducing the tape supplied from the tape supply unit 80 to the apparatus is coupled to the lower side wall of the main body 910. The tape inlet portion 950 is composed of an upper plate 951 and a lower plate 952 connected to each other. Especially, a stepped portion 952a is formed on the top surface of the lower plate 952 and through which the tape is introduced and transferred. Moreover, a through-hole 951a through which the pressing plate 943 of the tape stopper 940 comes in and out is provided at a predetermined position of the upper plate 951.

Moreover, support blades 951b and 952b for preventing the tape from being bent when the tape cutting portion 930 is returned from the side of the tape fixing portion 920 to the original position are provided on the upper plate 951 and the lower plate 952.

Referring to FIG. 26, a stepped portion 9110 is formed on an end portion of the third driving shaft 911c, with which the top end of the stopper shaft 941 comes in contact. Accordingly, if the driving shaft 911c is moved to the inside of the main body 910 as the actuator 96 is driven, the stopper shaft 941 is operated downward. If the stopper shaft 941 is moved downward, the pressing plate 943 presses down the tape in the tape inlet portion 950 to restrict the transfer of the tape.

The tape fixing portion 920 is coupled to the upper plate of the main body 910 at a position corresponding to the side wall of the main body 910 by means of a bolt, etc. The tape fixing portion 920 and the main body 910 make an n-letter shape generally. The body 921 of the tape fixing portion 920 plays a role of a support stand for the tape cutting portion 930 (to be described later) during the taping process.

A through-hole 922 through which a cam shaft 923 is inserted movably up and down is formed in the middle portion of the body 921. The cam shaft 923 is elastically supported on the upper plate of the main body 910 by an elastic spring 923a. A cam 924 is coupled to the top end of the cam shaft 923. The cam 924 is driven by the first driving shaft 911a. A receiving groove 925 for receiving the tape introduced through the tape inlet portion 950 is provided on the lower portion of the body 920. A fixing plate 926 for fixing the tape introduced to the receiving groove 925 is connected to the lower end of the cam shaft 923.

If the first driving shaft 911a is moved to the side of the main body 910 as the actuator 96 is driven, the cam 924 is rotated by the first driving shaft 911a and thereby the cam shaft 923 moves upward. Moreover, if the driving shaft 911a is moved from the inside to the outside of the main body 910, the cam 924 is rotated to the original position and, at the same time, the cam shaft 923 is moved downward by the elastic spring 923a. Then, the fixing plate 926 is moved downward along with the cam shaft 923 being moved downward to press down the introduced tape to be fixed.

The tape cutting portion 930 includes a tape pressing block 931, a cutter 932, and a support block 933.

The tape pressing block 931 is fixedly connected to the second driving shafts 911b. The cutter 932 and the support block 933 are coupled in turn to the lower portion of the tape pressing block 931 by means of a bolt, etc. If the driving shafts 911b are moved to the side of the main body 910 as the actuator 96 is driven, the tape cutting portion 930 is simultaneously moved to the side of the tape fixing portion 920. At this time, the tape pressing block 931 performs a tape pressing process for the optical fiber roll along with the body 921 of the tape fixing portion 920.

The cutter 932 performs a tape cutting process along with the tape pressing process. A stepped portion 921a is formed in a portion corresponding to the cutter 932 in the body 921 of the tape fixing portion 920. The stepped portion 921a is to facilitate the tape cutting process of the cutter 932.

A guide groove 933a through which the support blade 951b provided on the upper plate 951 of the tape inlet portion 950 and the tape are introduced is provided on the lower portion of the support block 933. Moreover, a blade 933b for introducing the end of the tape cut by the cutter 932 into the receiving groove 925 of the body 921 in the tape fixing portion 920 and supporting the same is provided on the lower portion of the support block 933.

The taping unit 90 is also configured in preparation for a case where a tape used in tying the rewound optical fiber roll shows excellent adhesion force for the same material, whereas, it does not adhere to the other material. Accordingly, the configuration of the taping unit 90 may be varied in accordance with the kind or adhesion force of the tape used in tying the rewound optical fiber roll. That is, various modifications and variations of the present invention can be made thereto by those skilled in the art without departing from the spirit and the technical scope of the present invention.

Next, the operation of the apparatus configured as described above will be described with reference to FIG. 27 that is a perspective view showing an overall outer appearance of the optical fiber rewinding apparatus in accordance with the present invention and FIG. 28 that is a diagram illustrating the operation thereof.

First, an optical fiber roll wound in the unit of 10 km, for example, is mounted on the bobbin 11 of the pay-off unit 10. The optical fiber roll mounted on the bobbin 11 may be a multi-core optical fiber or a single-core optical fiber that is required to be rewound. The optical fiber drawn from the optical fiber roll is maintained as it is introduced into the cutting unit 50 through the tension adjusting unit 20 and the feeding unit 30.

Moreover, in the tape supply unit 80, a tape roll for tying the optical fiber roll is mounted on the reel 811 of the tape holder 810. The tape drawn from the tape roll is introduced into the taping unit 90 by way of the driving roller 821, the support roller 822, the dancer 824 and the guide bar 828 in turn. Furthermore, in the taping unit 90, the tape drawn from the tape supply unit 80 is introduced through the tape inlet portion 950 of the taper 91 and fixed on the tape fixing portion 920.

To operate the rewinding apparatus of the present invention, a worker inputs process conditions such as the kind, length and amount, etc. of the optical fiber to be rewound through the control panel 100 as described above.

The controller stores the process conditions input by the worker in the memory and controls the overall apparatus based on the same.

First, in an initial operation, the controller initiates the overall apparatus based on detection signals applied from the sensors S1 to S7 established in the respective units. Moreover, referring to FIGS. 13 and 14, if the optical fiber to be rewound is a single-core optical fiber that requires the traversing control, the controller drives the cam motor 62 to move the guide roller 61 to the outside and performs the traversing process in which the guide roller 61 is reciprocated in a direction perpendicular to the transfer direction of the optical fiber during the operation of the apparatus.

If the initialization process for the apparatus is completed, the controller performs the rewinding process of the optical fiber.

The controller drives the bobbin motor 12 to pay off the optical fiber from the bobbin 11 and, at the same time, drives the driving motor 314 in the feeding unit 30 of FIG. 5 to rotate the driving roller 31, thus supplying the optical fiber to the take-up unit 70. The optical fiber supplied from the feeding unit 30 is transferred to the take-up unit 70 through the guiding unit 40. Moreover, the driving motor 314 is driven for a predetermined time, that is, until the optical fiber is introduced through the inlet groove 710 provided on the winding wheel 71 of the take-up unit 70 and arrives at a position where the clamp 713 is mounted.

In the take-up unit 70 in FIGS. 16 to 18, the controller drives the actuator 742 to move the discharger 73 to the side of the winding wheel 71 in the beginning stage. If the discharger 73 is moved to the side of the winding wheel 71, the operation pin 714 positioned in the accommodating groove 732 of the discharger 73 is moved to the inner circumferential surface of the receiving portion 731, thus pushing up the clamp 713. This state is maintained for a predetermined time, that is, until the optical fiber is introduced from the feeding unit 30 through the guiding unit 40 to the inlet groove 710 of the winding wheel 71.

If the introduction of the optical fiber is completed, the controller stops the operation of the driving motor 314 of the feeding unit 30 and, at the same time, stops the operation of the bobbin motor 12 of the pay-off unit 10. Then, the controller drives the actuator 742 of the take-up unit 70 to return the discharger 73 to the initial position, that is, to the side of the driving motor 72. If the discharger 73 is returned to the initial position, the operation pin 714 positioned on the inner circumferential surface of the discharger 73 is introduced into the accommodating groove 732 and thereby the clamp 713 is moved downward by the elastic member 713a. Accordingly, the optical fiber introduced through the inlet groove 710 of the winding wheel 71 is caught by the clamp 713 and the lower piece 712.

If the fixation of the optical fiber by the clamp 713 is completed, the controller drives the bobbin motor 12 of the pay-off unit 10 and, at the same time, drives the driving motor 72 of the take-up unit 70. Accordingly, the optical fiber is wound on the outer circumference of the winding wheel 71 of the take-up unit 70. Such a winding process is continued for a predetermined time, that is, until the optical fiber of which length was set by the worker is completely wound. Moreover, at this time, it is desirable that the driving motor 72 be driven in the sequential order of low speed-high speed-low speed to reduce the load applied to the other units.

Moreover, in this winding process, if the traversing function is set in advance, the guide roller 61 of the traversing unit 60 is moved to the outside by the controller as described above. Accordingly, the optical fiber being wound along the outer circumference of the winding wheel 71 moves upward to be guided by the guide roller 61. And the controller reciprocates the guide roller 61 in a direction perpendicular to the transfer direction of the optical fiber, thus performing the traversing process.

If the winding process for the winding wheel 71 is completed, the controller stops the operations of the driving motor 72 and the bobbin motor 12 and, at the same time, drives the taping unit 90 to perform the taping process for the optical fiber roll rewound on the winding wheel 71.

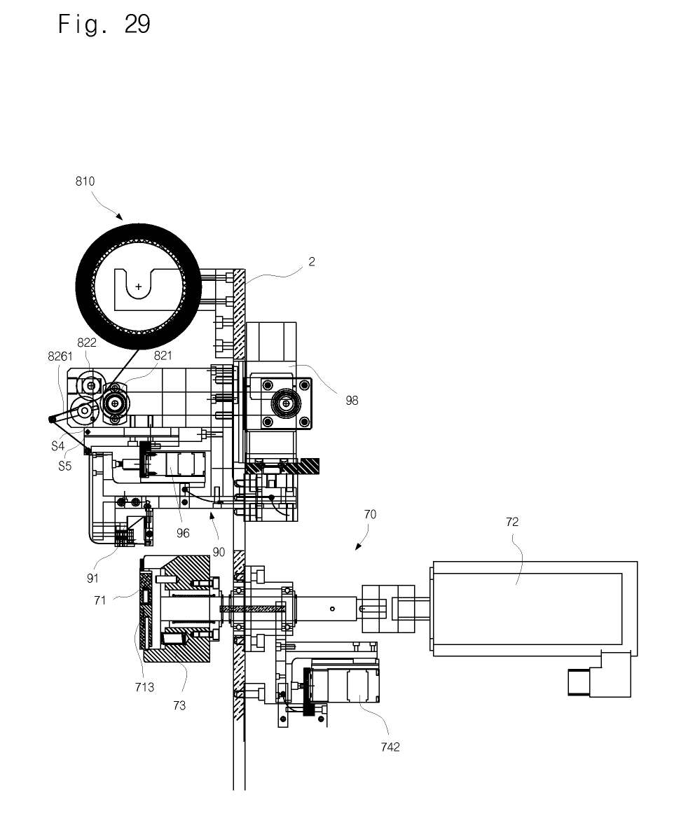

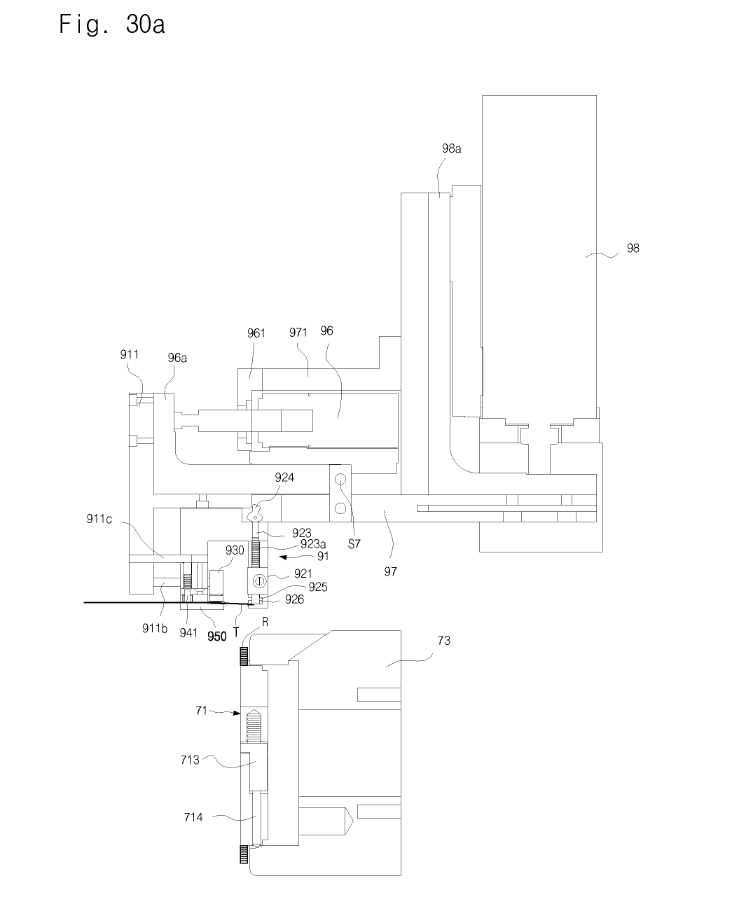

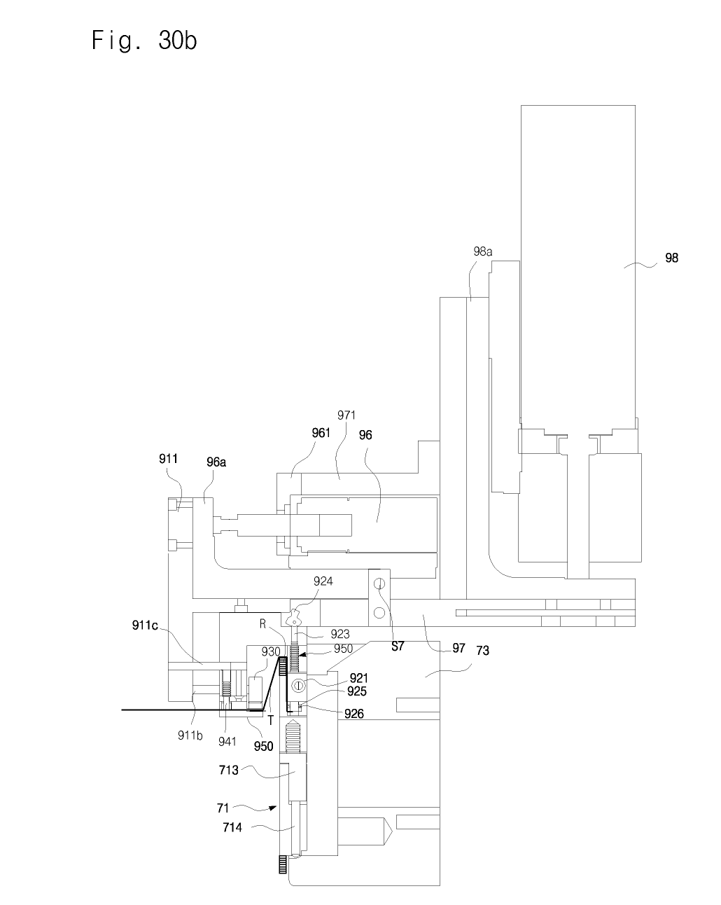

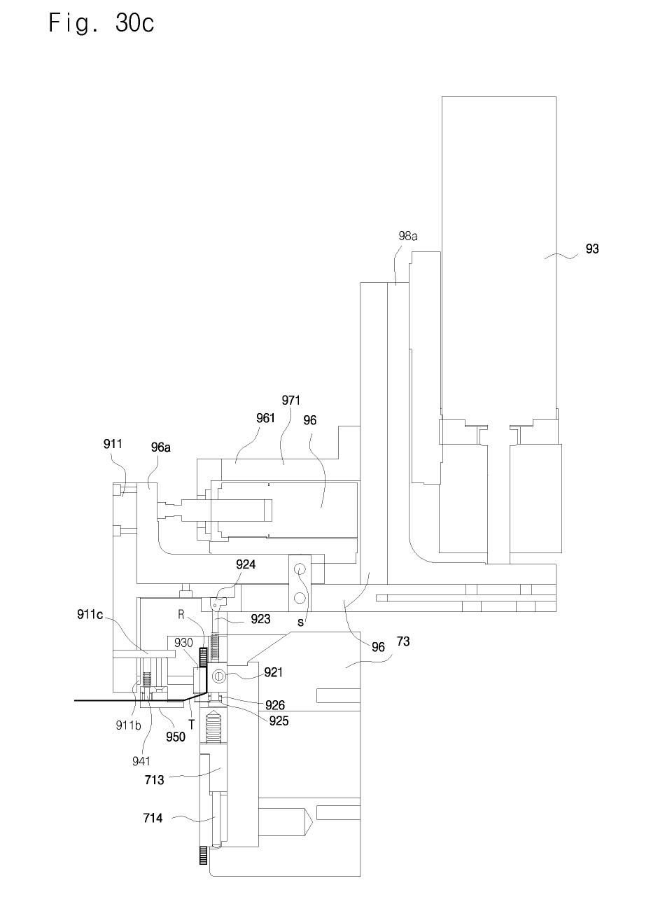

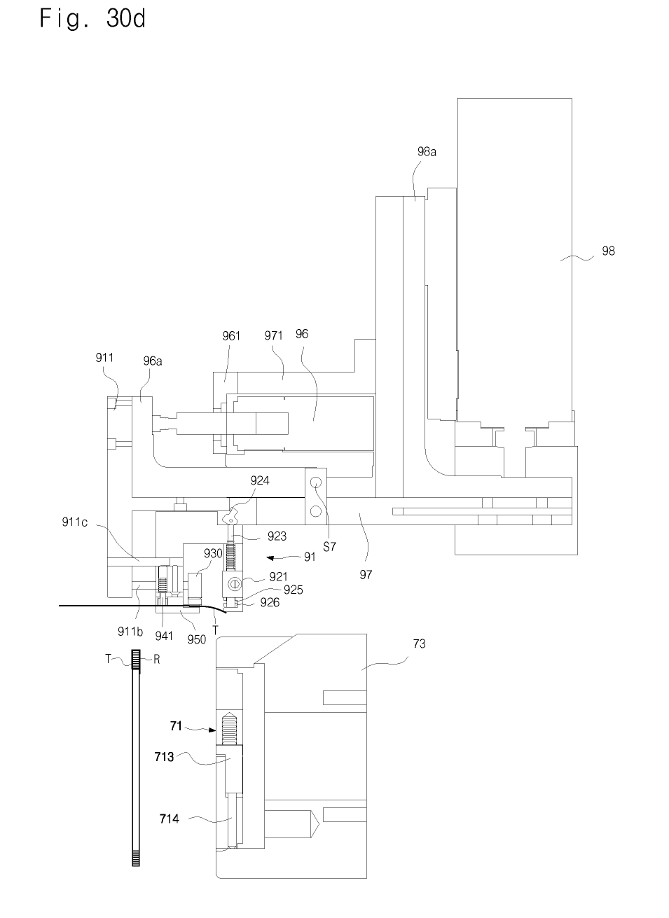

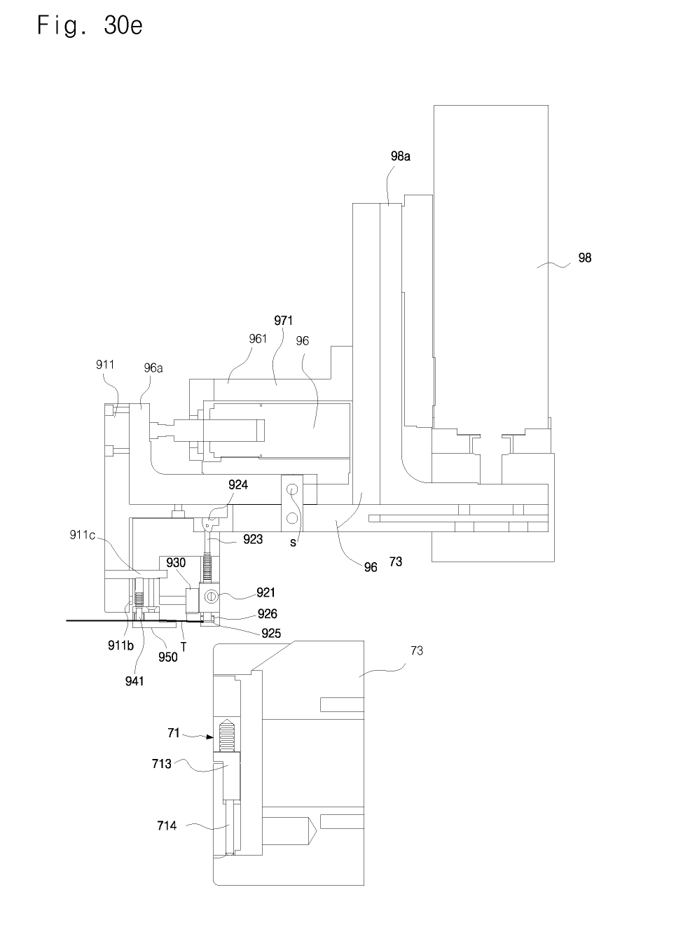

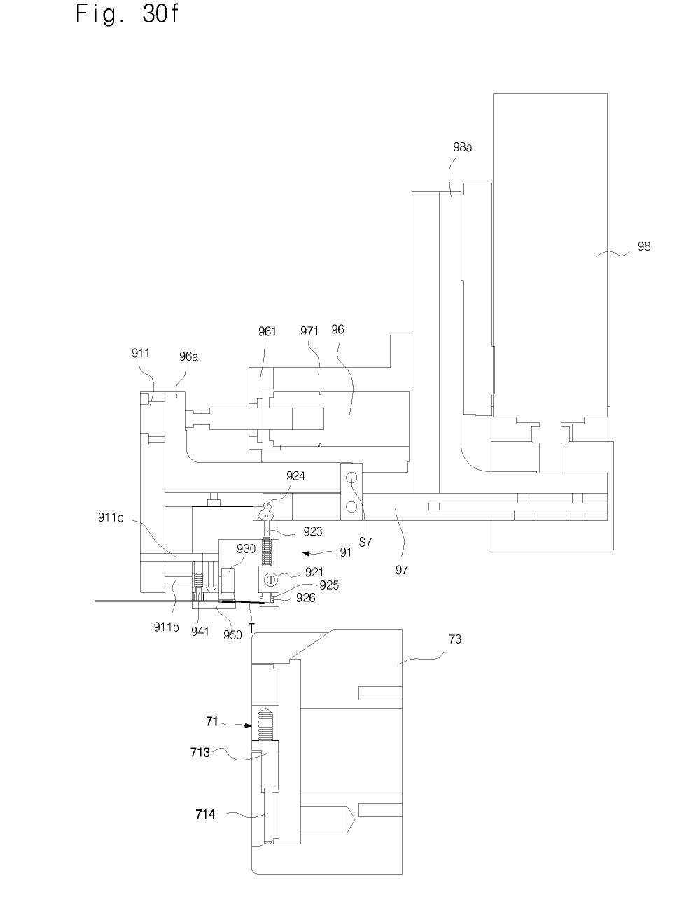

FIGS. 29 and 30 are diagrams illustrating the taping process of the taping unit 90.

FIG. 30a is a sectional view showing an operation state of the taping unit 90 before performing the taping process. As described above, in the taping unit 90, the tape T supplied from the tape supply unit 80 is introduced through the tape inlet portion 950 and received in the receiving groove 925 of the tape fixing portion 920. Moreover, as the bracket 911 is moved to the outside of the main body 910, the cam shaft 923 of the tape fixing portion 920 is moved downward by the elastic spring 923a. Accordingly, in this state, the fixing plate 926 presses down the tape received in the receiving groove 925 to be fixed.

In the above state, if the optical fiber winding process for the winding wheel 71 of the take-up unit 70 is completed, the controller drives the actuator 98 of the taping unit 90 to move the support body 97 downward. If the support body 97 is moved downward, the taper 91 coupled thereto is moved downward.

As described above, the tape fixing portion 920 and the main body 910 in the taper 91 make an n-letter shape generally. Moreover, in the take-up unit 70, the grooves 711b, 715a and 73a are provided on the upper sides of the winding wheel 71, the fixing plate 715 and the discharger 73, respectively. Accordingly, if the taper 91 is moved downward, the tape fixing portion 920 is inserted into the space defined by the grooves 711b, 715a and 73a. As a result, as shown in FIG. 30b, the optical fiber roll R wound on the winding wheel 71 of the take-up unit 70 pushes the tape T arranged in the horizontal direction on the lower side of the taper 91 and enters the space of the n-letter shape defined by the main body 910 and the tape fixing portion 920.

At this time, in the tape supply unit 80, if the optical fiber roll R is moved into the taper 91 and pushes the tape T upward, the tension of the tape T supplied to the taping unit 90 is increased and thereby the dancer 824 is rotated downward. Accordingly, the dancer arm 8241 is detected by the sensor S5.

If the detection signal is input from the sensor S5, the controller drives the driving motor 823 to draw a predetermined amount of the tape from the reel 811 and thereby the dancer 824 is returned to the original position.

If the down movement of taping unit 90 is completed, the controller drives the actuator 98 to move the first to third driving shafts 911a to 911c to the side of the main body 910. If these driving shafts 911a to 911c are moved to the side of the main body 910, the cam 924 is rotated by the first driving shaft 911a and thereby the cam shaft 923 is moved upward as shown in FIG. 30c.

Moreover, as the tape cutting portion 930 is moved by the second driving shafts 911b to the side of the tape fixing portion 920, the tape T surrounds the optical fiber roll R by the close contact with the pressing block 931 and the body 921 to be adhered thereto. Then, the tape T is cut by the cutter 932.

Furthermore, as the stopper shaft 941 is moved downward by the third driving shaft 911c, the pressing plate 943 presses down the tape T in the tape inlet portion 950, thus preventing the tape from being drawn toward the tape fixing portion 920 during the tape cutting process.

Subsequently, if the taping process for the optical fiber roll R is completed according to the above operations, the controller drives the actuator 96 to move the first to third driving shafts 911a to 911c to the outside of the main body 910.

Accordingly, as the first driving shaft 911a is moved to the outside of the main body 910, the cam shaft 923 of the tape fixing portion 920 is moved downward by the elastic spring 923a. Moreover, with the movements of the second and third driving shafts 911b and 911c, the tape cutting portion 930 and the tape stopper 940 are returned to the original positions.

Then, the controller drives the actuator 96 and then drives the actuator 98 to move the taping unit 90 upward. At this time, the actuator 98 is driven after a predetermined time from the operation of the actuator 96, that is, directly after the tape cutting portion 930 is moved in the horizontal direction and gets out of the inside the optical fiber roll. The reason for this is to move the taping unit 90 upward while the tape stopper 940 is operated so that the end of the tape being drawn from the tape inlet portion 950 does not touch the tape wound on the optical fiber roll unnecessarily when the taping unit 90 moves upward, thus preventing the tape from being drawn from the tape inlet portion 950.

Meanwhile, if the taping unit 90 is moved upward, the end of the tape drawn from the tape inlet portion 950 droops downward by the optical fiber roll wound on the winding wheel 71 as shown in FIG. 30d.

Accordingly, if the taping unit 90 is moved upward, the controller drives the actuator 96 repeatedly to reciprocate the first to third driving shafts 911a to 911c, thus fixing the end of the tape in the receiving groove 925 of the tape fixing portion 920.

That is, the controller drives the actuator 96 to move the first to third driving shafts 911a to 911c to the side of the main body 910. Accordingly, like the above-described operation, the stopper shaft 941 is operated downward, the tape cutting portion 930 is moved to the side of the tape fixing portion 920, and the cam shaft 923 of the tape fixing portion 920 is moved upward.

If the second driving shafts 911b are moved to the side of the tape fixing portion 920, the end of the tape is lifted upward by the blade 933b provided on the lower side of the tape cutting portion 930 and received in the receiving groove 925 of the tape fixing portion 920 as shown in FIG. 30e.

Subsequently, the controller drives the actuator 96 to move the first to third driving shafts 911a to 911c to the original positions, that is, to the outside of the main body 910. If the first driving shaft 911a is moved to the outside of the main body 910, the cam shaft 923 of the tape fixing portion 920 is moved downward by the elastic spring 923a and thereby the fixing plate 926 presses down the end of the tape T received in the receiving groove 925 to be fixed.

Accordingly, the taping unit 90 is returned to the original state of before the taping process is performed as shown in FIG. 30f.

If the taping process by the taping unit 90 is completed, the controller drives the driving motor 53 of the cutting unit 50 to rotate the rotational cutter 51 at 90 degrees, thus cutting the optical fiber.

Next, if the optical fiber cutting process is completed, the controller drives the actuator 742 of the take-up unit 70 to move the discharger 73 to the side of the winding wheel 71, thus separating the optical fiber roll wound on the winding wheel 71 to the outside.

At this time, as the discharger 73 is moved to the side of the winding wheel 71, the operation pin 714 positioned in the accommodating groove 732 of the discharger 73 is moved on the inner circumferential surface of the receiving portion 731, thus pushing up the clamp 713. That is, the take-up unit 70 is also returned to the initial state.

Henceforth, the above-described processes are repeated to perform the optical fiber rewinding operations continuously and, if the rewinding operations corresponding to the amount that the worker input are completed, the controller terminates all the rewinding operations.

Meanwhile, reference numeral 200 in FIGS. 27 and 28 denote a loading device for loading the rewound optical fiber rolls in the optical fiber rewinding apparatus, and numeral 300 denotes a transfer device for receiving the optical fiber rolls discharged from the take-up unit 70 and automatically transferring the same to the loading device 200. These devices 200 and 300 are auxiliarily added to the optical fiber rewinding apparatus in accordance with the present invention.

The loading device 200 includes a plurality of holding stands 210 for loading the optical fiber rolls and these holding stands are connected integrally by a frame 220. The frame 220 is moved up, down, left and right along a horizontal rail 230 and a vertical rail 240.

Moreover, the transfer device 300 includes a rotatable body 310. A shaft 320 operated up and down is mounted on the body 310. A guide bar 330 is coupled to an end portion of the shaft 320 through a cam, not depicted. If the shaft 320 is driven downward, an end portion of the guide bar 330 is arranged toward the upper side and, if the shaft 320 is driven upward, the end portion of the guide bar 330 is arrange toward the lower side.

The end portion of the guide bar 330 is arranged adjacent to the front of the winding wheel 71 so as to receive the optical fiber rolls discharged from the take-up unit 70. If a predetermined amount of the optical fiber rolls is received in the guide bar 330, the body 310 is rotated toward the loading device 200 and, at the same time, the shaft 320 is moved upward. If the shaft 320 is moved upward, the guide bar is inclined toward the lower side and thereby the optical fiber rolls loaded on guide bar 330 are separated from the guide bar 330 to be transferred to the holding stands 210.

Since it is not necessary that the loading device 200 and the transfer device 300 have a specific configuration, their detailed description will be omitted.

As such, the preferred embodiment in accordance with the present invention has been described. Since the rewinding process of the optical fiber and the taping process therefor are all automatically performed in the present invention, it is possible to facilitate the rewinding process of the optical fiber and reduce the working time remarkably.

That is, the present invention provides an optical fiber rewinding apparatus that can perform a series of processes from rewinding to taping the optical fiber full automatically.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

What is claimed is:

1. An optical fiber rewinding apparatus rewinding a predetermined amount of optical fiber from an optical fiber bobbin on which a large amount of the optical fiber is wound, the apparatus comprising:
a pay-off unit supplying the optical fiber to be rewound;
a feeding unit feeding the optical fiber supplied from the pay-off unit to a take-up unit;
a tension adjusting unit maintaining a tension of the optical fiber supplied from the pay-off unit to the feeding unit at a constant level;
a cutting unit cutting the optical fiber supplied from the pay-off unit in a predetermined length;
a take-up unit winding the optical fiber supplied from the pay-off unit to form an optical fiber roll;
a tape supply unit supplying tape for taping the optical fiber roll;
a taping unit taping the optical fiber roll rewound by the take-up unit; and
a controller controlling optical fiber rewinding processes.

2. The optical fiber rewinding apparatus as recited in claim 1,
wherein the feeding unit comprises:
a first driving roller and a first support roller that are driven by being engaged with each other;
a first driving motor driving the first driving roller; and
a first guide roller guiding the optical fiber supplied from the tension adjusting unit to the side of the driving roller, and
wherein a shaft of the first support roller is established movably against the first driving roller.

3. The optical fiber rewinding apparatus as recited in claim 1,
wherein the pay-off unit comprises:
a bobbin on which the optical fiber is wound;
a bobbin motor rotating the bobbin;
a decelerator decreasing the rotational force of the bobbin motor; and
a first sensor for detecting an amount of the optical fiber wound on the bobbin, and
wherein the controller controls the operation of the pay-off unit based on a detection signal of the first sensor.

4. The optical fiber rewinding apparatus as recited in claim 1,
wherein a traversing unit adjusting an inlet angle of the optical fiber introduced into the take-up unit is further provided in front of the take-up unit, and
wherein the traversing unit comprises:
a second guide roller, established on a transfer path of the optical fiber supplied to the take-up unit and guiding the transfer of the optical fiber; and
a cam motor reciprocating the second guide roller in a direction perpendicular to the transfer direction of the optical fiber.

5. The optical fiber rewinding apparatus as recited in claim 4,
wherein the controller adjusts a movement distance of the second guide roller to selectively connect the second guide roller to the optical fiber.

6. The optical fiber rewinding apparatus as recited in claim 1,
wherein the cutting unit comprises:
a rotational cutter;
a second driving motor driving the rotational cutter; and
a cutting support established in the rotational direction of the rotational cutter, and
wherein the top surface of the cutting support is formed inclined.

7. The optical fiber rewinding apparatus as recited in claim 1,
wherein a guiding unit guiding the optical fiber drawn from the feeding unit to the take-up unit is further included.

8. The optical fiber rewinding apparatus as recited in claim 7,
wherein first and second rails of the guiding unit are connected spaced from each other to form a guide groove on the top thereof and elastic springs are arranged between the first and second rails at regular intervals so as to adjust the spacing interval thereof.

9. The optical fiber rewinding apparatus as recited in claim 1,
wherein the take-up unit comprises:
a winding wheel including an upper piece and a lower piece of a semicircular shape connected spaced from each other;
a third driving motor rotating the winding wheel;
a discharger separating the optical fiber roll wound on the winding wheel from the winding wheel; and
a first actuator operating the discharger in a direction horizontal to the winding wheel,
wherein a clamp provided in the middle portion of the upper and lower pieces and fixing the optical fiber introduced into an inlet groove is included,
wherein the clamp is configured to operate in connection with the movement of the discharger, and
wherein a groove for a taping process is provided on the upper sides of the winding wheel and the discharger.

10. The optical fiber rewinding apparatus as recited in claim 1,
wherein the tape supply unit comprises:
a tape holder for rotatably mounting a tape roll; and
a tape supplier for drawing the tape from the tape holder and providing the same to the taping unit,
wherein the tape supplier comprises:
a second driving roller and a second support roller for drawing the tape from the tape roll;
a dancer rotating in accordance with a tension of the tape supplied to the taping unit;
a second sensor for detecting a rotational position of the dancer; and
a third driving motor for driving the driving roller, and
wherein the controller controls the operation of the third driving motor based on a detection signal of the second sensor.

11. The optical fiber rewinding apparatus as recited in claim 10,
wherein a third sensor for detecting a minimum rotational position of the dancer is further included, and
wherein the controller stops the overall operation of the apparatus if the position of the dancer is detected by the third sensor.

12. The optical fiber rewinding apparatus as recited in claim 10,
wherein the second sensor is established so as to vary the position thereof in the horizontal direction.

13. The optical fiber rewinding apparatus as recited in claim 1,
wherein the taping unit comprises:
a taping means performing a taping process for the optical fiber roll wound by the take-up unit;
a second actuator driving the taping means;
a support body to which the taping means and the second actuator are coupled; and
a third actuator driving the support body in the up and down direction.

14. The optical fiber rewinding apparatus as recited in claim 13,
wherein the taping means comprises:
first to third shafts driven by the second actuator;
a tape inlet portion for introducing the tape supplied from the tape supply unit;
a tape fixing portion, operated in connection with the first shaft, for catching the tape being introduced through the tape inlet portion and fixing the same, if the first shaft is driven in a first direction;
a tape cutting portion, operated in connection with the second shaft, for performing processes of tape-pressing and cutting the optical fiber roll, if the second shaft is drive in a second direction that is opposite to the first direction;
a tape stopper, operated in connection with the third shaft, for stopping the transfer of the tape being introduced through the tape inlet portion, if the third shaft is drive in the second direction; and
a main body to which the tape fixing portion, the tape cutting portion and the tape stopper are coupled.

15. The optical fiber rewinding apparatus as recited in claim 14,
wherein the main body makes an n-letter shape generally in a state where the tape fixing portion is coupled thereto.

16. The optical fiber rewinding apparatus as recited in claim 1,
wherein an optical fiber roll transfer device for receiving the optical fiber roll discharged form the take-up unit and loading the same on a loading device.
